(19) United States
(12) Patent Application Publication
(10) Pub. No.: US 2022/0005063 A1
(43) Pub. Date: Jan. 6, 2022

(54) System and Methods for Delivering Targeted Marketing Offers to Consumers via Mobile Application and Online Portals

(71) Applicant: Cardlytics, Inc, Atlanta, GA (US)

(72) Inventors: Nicholas E NEUENSCHWANDER, Decatur, GA (US); Ran XU, Alpharetta, GA (US); Tina Chia-G YU, Marietta, GA (US)

(21) Appl. No.: 16/918,413

(22) Filed: Jul. 1, 2020

(51) Int. Cl. G06Q 30/02; G06N 3/08

(52) U.S. Cl. CPC G06Q 30/0224; G06N 3/08; G06Q 30/0215; G06Q 30/0239; G06Q 30/0222; G06Q 30/0201

(57) ABSTRACT

A system and methods for delivering real-time targeted marketing offers (“TMOs”) to consumers during a session with an online (web-based) Internet portal, particularly suitable for financial institution portals of financial institutions. An offer management system (“OMS”) receives information corresponding to an advertising campaign of an advertiser corresponding to terms of a TMO to be provided to a consumer accessing the financial institution portal, and provides advertising campaign data corresponding to the TMO and to an offer-triggering event (“OTE”) to an offer placement system (“OPS”). An OPS receives the advertising campaign data, determines the occurrence of the OTE by a consumer during an online session with the financial institution portal, and delivers information corresponding to the TMO to the consumer. In response to the OTE, such as display of a list of transactions, the predetermined TMO is delivered to the consumer during the online session.

### TECHNICAL FIELD

The present systems and methods relate generally to electronic, computer-based targeted marketing systems (“TMS”), and more particularly to systems and methods for providing targeting marketing offers (throughout this disclosure targeted marketing offers will be referred to as simply “TMO” in the singular and “TMOs” in the plural) to consumers using financial services type systems such as financial institution portals, emails, and phone applications

### BACKGROUND

Online financial services provided by financial institutions such as banks, credit unions, savings & loans, credit providers, and brokerage institutions are popular among consumers as a way to effectively manage their finances. Many people use such services to monitor their bank accounts and cash holdings, securities accounts, savings accounts, and so forth, and utilize financial-institution-provided online bill payment or check writing services. Generally, these online financial services are mobile applications Internet-accessible via financial institution websites or web pages, including as viewed via mobile devices or smart device applications. As referred to herein, such online financial services type online systems will be referred to as “financial institution portals”, although other terms may apply to such services by different types of institutions.

In a traditional financial institution portal, users are typically provided with a listing of their accounts, and a further sub-listing of their recent transactions associated with those accounts. Each transaction will often include the date of the purchase or transaction, the amount of the transaction, the form in which the transaction occurred (i.e., check, credit card, etc.), and the retailer, service provider, or other establishment with which the transaction occurred. Based on the details available with each transaction, as well as the ease of use of most financial institution portals, many consumers rely heavily on these portals to manage their finances and investments, stay on top of budgets, pay bills, and track their purchases. Additionally, with the advent and increased use of mobile devices (e.g., cell phones, smart phones, tablets, etc.), consumers have constant access to their online services and accounts.

In order to provide detailed and up-to-date information regarding transactions, purchases, and accounts to portal users, banks and other financial service providers must keep thorough records of those transactions, and employ highly-sophisticated operational systems to maintain and organize such information. Accordingly, banking systems can provide a rich intelligence about the purchasing habits and propensities of consumers. It would be highly beneficial to most advertisers to have access to such detailed purchase information; however, due to strict privacy laws and regulations that limit how financial institutions can share consumer data, advertisers have in the past been unable to access this valuable information.

Certain types of TMSs are known to be in use. The term “targeted marketing” generally refers to systems that enable the identification of particular classes or segments of consumers and the delivery by advertisers of specialized targeted marketing information and/or offers to such consumers. Consumers are often segmented into classes and subclasses based on age, gender, geography, socio-economic status, types of purchases, and other indicia. The specialized targeted marketing information provided to these identified classes of consumers can include special discounts on product purchases, coupons, rewards program points, or other similar incentives as regards specific products or services provided by advertisers. Generally, the more information known by an advertiser, the more targeted, specialized and valuable advertisements become.

Traditionally, marketers relied on general information such as their own historical sales data or common geographic data in order to target advertisements (in the form of mailers, television advertisements, etc.) to customers. While this type of targeted marketing does provide some benefit over undirected, mass marketing, it is not as specialized or precise as most advertisers would prefer. Even with the advent and widespread use of the Internet (and Internet advertisements), targeted marketing still does not reach the level of detail that would optimize the effectiveness of that marketing.

The ability to target advertisements to individual consumers based on each consumer's actual purchases would provide a highly-effective way to present products and/or services to consumers. For example, each consumer could be presented with advertisements for goods and/or services he or she regularly buys in the hopes of increasing the consumer's purchase of those goods and/or services. Or, the consumer could receive advertisements or offers for goods and/or service that are related to the consumer's past purchases (e.g., if a consumer recently purchased a lawn mower, then ads for related goods, such as lawn fertilizer or a hedge trimmer, could be provided). Additionally, advertisements could be presented based not on the specific goods and/or services purchased, but on peripheral information related to those purchases, such as the consumer's typical purchase amounts (e.g., consumer buys luxury items or is more cost-conscious), the geographic location of the consumer's transactions, the category of purchases, the frequency of purchases, the types of merchants at which the consumer often (or rarely) shops, etc. However, because merchants and advertisers traditionally did not have access to individual consumer purchase histories (such as the types of products purchased, dates purchased, amounts spent, specific merchants from which items were purchased, location of purchase, etc.), such targeted marketing were previously unavailable.

Further, many types of offers or redemptions associated with targeted marketing campaigns (“TMC” in the singular and “TMCs” in the plural) are difficult for consumers to use and problematic for advertisers to track. For example, many consumers are unlikely to use coupons that require printing from a computer or clipping from a newspaper in order to be used. Accordingly, many consumers ignore such coupons and their associated advertisements. Additionally, many retailers have individual rewards programs through device applications to engage customers. However, this requires downloading multiple applications for each retailer.

Another issue related to traditional TMSs is that advertisers generally only have records as to their own sales data, and they do not have access to information regarding how much consumers spend or how often consumers shop at competitors of the advertisers, or even at unrelated advertisers. Such transaction data, if available, could prove invaluable for marketing and profitability purposes. As an example, one class of consumers could be that of purchasers of home-delivered pizzas. An advertiser (e.g., hypothetical advertiser “Pizza Pub”) that delivers pizzas to the homes of customers may rely on past purchases or demographic information within a community to target mailers or television advertisements to those consumers. However, if that advertiser had access to information relating to existing customers of a competitor (e.g., hypothetical merchant “Pizza King”), then the advertiser could target advertisements to the competitor's customers in the hopes of drawing them away from the competitor. Further, the advertiser could then analyze information about the competitor's customers to determine what made the customers choose the competitor's product initially. Additionally, in fluctuations in the market, advertisers could use competitive information to establish spending behavior habits. For example, if Pizza Pub closed their doors, Pizza King could target advertisements to the competitor's customers to establish as a new go-to for previous competitor's customers. However, it traditionally has been difficult for advertisers in most markets to obtain marketing intelligence about consumers of their competitors.

Additionally, financial institutions are always looking for ways to boost their revenue streams and increase customer loyalty. Presentation of valuable marketing offers (such as rebates or savings on goods and/or services) to consumers that use particular financial institution accounts is one way to increase loyalty and entice consumers to use payment mechanisms associated with those accounts (i.e., credit cards, bank cards, etc.). However, most banks have in the past lacked the internal infrastructure necessary to effectively integrate advertisements from third parties into their existing financial institution portals. If an advertiser could work with a bank to extend offers to its customers based on the bank's knowledge of what its customers purchase, while preventing the advertiser from accessing sensitive or consumer-identifying data, then that information could be used to provide valuable and TMOs to consumers that are easy for the consumers to redeem, which would in turn lead to greater profits and increased customer loyalty for all parties involved.

A solution to the above challenges has been developed by Cardlytics, Inc., as described in U.S. Pat. No. 8,515,810 (the '810 patent), which is hereby incorporated by reference. In this patented solution, a system and method are described for delivering TMOs to consumers during a session with an online (web-based) Internet portal, particularly suitable for financial institution portals of financial institutions. An offer management system (“OMS”) receives information corresponding to an advertising campaign of an advertiser corresponding to terms of a TMO to be provided to a consumer accessing the financial institution portal, and provides advertising campaign data corresponding to the TMO and to an offer-triggering event to an offer placement system (“OPS” in the singular and “OPSs” in the plural). An OPS receives the advertising campaign data, determines the occurrence of the offer-triggering event (“OTE” in the singular and “OTEs” in the plural) by a consumer during an online session with the financial institution portal, and delivers information corresponding to the TMO to the consumer. In response to the OTE, such as display of a list of transactions, the predetermined TMO is delivered to the consumer during the online session.

The '810 patent introduced a significant step forward over prior systems and method, to allow for TMOs to consumers via an financial institution portal. However, in the '810 patent, TMOs made to consumers are generally based on prior transactions or purchases made by the consumers, patterns in those transactions, overall consumer spending habits, and the like, whereby this past data is collected overtime, and analyzed in batches. The TMS of the '810 patent matches specific TMOs to consumers based on TMO criteria and associated OTEs defined by advertisers, provides matched TMOs to identified consumers via the consumers' financial institution portals, etc. While this system and process of the '810 patent works well, because the prior transactions and purchases are collected over time and analyzed in batches, the matched TMOs aren't always able to be provided to consumers in real-time.

Therefore, there is a long-felt but unresolved need for a system or method that interacts seamlessly with sophisticated banking systems and financial institution portals, or other transaction-centric information portals or data repositories, to provide real-time TMOs and advertisements to users of those portals, wherein such targeted marketing is related to each user's transactions and purchases displayed at the portal, as well as the user's purchase histories and/or spending habits. There is a further need for a system or method that enables simple and straightforward redemption of real-time TMOs while still allowing merchants and advertisers to track the effectiveness of their TMCs. There is yet a further need for a system or method that provides such real-time targeted marketing to financial institution customers without violating privacy laws and obtaining confidential customer information.

### BRIEF SUMMARY OF THE DISCLOSURE

Briefly described, and according to one embodiment, aspects of the present disclosure generally relate to systems and methods for providing real-time TMOs to consumers via online portals, particularly online financial institution portals and mobile applications associated with banks and other financial institutions. A TMS, as described herein, enables advertisers to construct highly-relevant advertisements and TMOs that are displayed to consumers as those consumers access and view their online financial institution account portals. The TMOs are generally targeted to specific types of consumers based on prior transactions or purchases made by the consumers, as well as patterns in those transactions, overall consumer spending habits, and other OTEs. Generally, the TMS matches specific TMOs to consumers based upon offer criteria and associated OTEs defined by advertisers, provides matched TMOs to identified consumers via the consumers' financial institution portals, tracks redemptions and other data associated with the TMOs, facilitates payment of rewards and redemptions to consumers based on redeemed TMOs, and enables a variety of other processes and functions as described in greater detail herein.

According to one aspect, the TMS includes an OMS and one or more OPSs, wherein each OPS operates in association or cooperation with a financial institution's online services system. Generally, the OMS enables creation of TMCs including one or more TMOs for eventual delivery to consumers based on information received by advertisers, transmission of campaign data to the OPS's, reporting of marketing data and campaign results to advertisers after TMOs have been displayed to consumers, collecting redemption funds from advertisers based on redeemed TMOs and distributing those funds to financial institutions, and other processes described in greater detail herein. Generally, operations of an OPS include matching received campaign data from the OMS with de-identified consumer transaction data received from financial institutions, injecting or merging TMOs into financial institution portals, sending TMC performance data to the OMS, organizing and transmitting redemption data to financial institutions based on TMO redemptions paid to consumers, and other processes described in greater detail herein.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates a high-level lifecycle of an exemplary consumer transaction, associated TMO, and redemption of that TMO according to one embodiment of a TMS constructed in accordance with the present disclosure and certain aspects of the inventions.

FIG. 2 illustrates a high-level overview of one embodiment of a TMS and its associated environment, according to one aspect of the disclosure.

FIG. 3 shows one embodiment of a system architecture for a TMS according to an aspect of the disclosure.

FIG. 4 is a flowchart illustrating the campaign generation process from the perspective of an advertiser according to an embodiment of the present TMS.

FIG. 5 is a flowchart is illustrating one embodiment of the campaign generation process from the perspective of the TMS.

FIG. 6A is an exemplary campaign table illustrating advertiser-entered, campaign-related data received during campaign generation.

FIG. 6B is an exemplary segment table illustrating advertiser-entered, segment-related data received during campaign generation.

FIG. 6C is an exemplary TMO table illustrating advertiser-entered, offer-related data received during campaign generation.

FIG. 7 is a flowchart illustrating the overall processes and functions performed by the OPS according to one embodiment of the present TMS, whereby transaction and purchase data may be received and acted on in real-time.

FIG. 8 illustrates a Kafka stream-processing structure used with the present invention, in one embodiment.

FIG. 9 illustrate the training that may be used to predict merchants, according to one embodiment of the present invention.

FIG. 10 illustrates the training that may be used for recommended TMOs, according to one embodiment of the present invention.

FIGS. 11 and 12 illustrate sample data that may be used with the present invention.

FIGS. 13 and 14 illustrate a process for injecting or merging matched TMOs into a display from an financial institution portal, where FIG. 13 is a flowchart illustrating an embodiment of a generalized process for injecting or merging TMOs, and FIG. 14 is a sequence diagram illustrating the sequence of steps associated with injecting matched TMOs into consumer financial institution portals via a document object model (DOM) injection process according to one embodiment of the TMS.

FIG. 15 illustrates an exemplary screen shot of a graphical user interface (“GUI”) associated with a typical exemplary consumer financial institution portal prior to injection of one or more TMOs into the portal.

FIG. 16 illustrates an exemplary screen shot of a GUI associated with a consumer financial institution portal or display with exemplary TMOs displayed therein according to an embodiment of the present TMS.

FIG. 17 is a flowchart illustrating an embodiment of the redemption process for determining whether one or more TMOs have been redeemed by a consumer, and reporting such redemption to the respective financial institution.

FIG. 18 is an exemplary offer impression table illustrating recorded TMOs that have been viewed by consumers based on consumer log-ins to financial institution portals.

FIG. 19 is an exemplary offer redemption table illustrating TMOs that have been redeemed by consumers based on redemption-qualifying purchases (“RQP” in the singular, “RDPs” in the plural).

FIG. 20 is an exemplary campaign results table illustrating aggregated TMO performance data (i.e., TMO impressions and redemptions).

FIG. 21 illustrates an exemplary screen shot of a GUI associated with a consumer financial institution portal with a TMO. RQP, and a RQP icon displayed therein according to an embodiment of the present TMS.

FIG. 22 illustrates an exemplary screen shot of a GUI associated with a consumer financial institution portal displaying a representative rewards page according to an embodiment of the present TMS.

FIG. 23 illustrates an exemplary OMS hardware architecture upon which an embodiment of the OMS may be implemented as herein described.

FIG. 24 illustrates an exemplary OPS hardware architecture upon which an embodiment of the OPS may be implemented as herein described.

### DETAILED DESCRIPTION

Prior to a detailed description of the disclosure, the following definitions are provided as an aid to understanding the subject matter and terminology of aspects of the present systems and methods, are exemplary, and not necessarily limiting of the aspects of the systems and methods, which are expressed in the claims. Whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Definitions/Glossary

Advertiser: an entity or an agency that represents an entity that provides or sells goods and/or services to consumers, and creates TMCs associated with those goods and/or services as described herein.

Aggregated Consumer Transaction Data: subset of de-identified consumer transaction data derived from all stored de-identified consumer transaction data in each OPS representative of consumers that satisfy a given targeted consumer segment (singular “TCS”, plural “TCSs”). Generally collected and transmitted to the OMS in response to an advertiser-initiated query during generation of a TMC. Generally synonymous with aggregated transaction data, aggregated consumer transactions, aggregated consumer transaction information, and aggregated population totals.

Campaign: see TMC.

Campaign Data: information associated with a TMC, as well as its associated TCSs and TMOs.

Campaign Performance Data: information associated with consumer interaction (i.e., results or performance) of a TMC.

Campaign Results Table: a data table or file in the TMS associating information relating to the performance (results) of one or more TMCs and associated TMO, including but not limited to: an offer identifier, aggregated offer impressions, aggregated offer redemptions, etc.

Campaign Table: a data table or file in the TMS associating information relating to one or more TMCs conducted by a particular advertiser (or merchant), including but not limited to: a campaign identifier, merchant or advertiser identifier, an author identifier, a campaign start date, a campaign end date, etc.

Consumer: an entity (individual, business, etc.) that holds at least one account with one or more financial institutions, and completes transactions and purchases with advertisers or merchants.

Consumer Transaction Table: a data table or file stored and retained within a financial institution's transaction system/processor associating information relating to particular consumer transactions, including but not limited to: a consumer name, a consumer identifier, a consumer account identifier, a transaction identifier, a location identifier (e.g., zip or postal code, city, state, etc.), a merchant identifier, an amount, a rewards type, etc.

De-Identified Consumer Transaction Table: a data table or file in the TMS, and specifically retained in one or more OPSs, associating de-identified information relating to particular transactions within a financial institution's online banking system that may be eligible to be matched with a TMO, including but not limited to: an account global unique identifier (GUID) that relates back to a particular consumer or customer of the financial institution, a transaction identifier, a location identifier (e.g., zip or postal code, city, state, etc.), a merchant identifier, an amount, a rewards type, etc.

De-Identified Transaction: a consumer transaction or purchase that has been processed according to an internal financial institution procedure to remove specific consumer- or account-identifying information. Generally synonymous with de-identified consumer transaction.

Demilitarized Zone (DMZ): a firewall configuration for selecting or demarcating local area networks. Computers residing behind the DMZ initiate secure outbound requests via the DMZ; computers within the DMZ in turn respond, forward, or re-issue requests out to the Internet or other public networks. Generally used in association with financial institution security protocols.

Dimension: a delineating category or information associated with a TCS that serves to narrow the population of consumers that may receive a TMO based on criteria associated with specific consumer transactions or other OTEs (OTEs), including but not limited to: a merchant or advertiser category (e.g., retail, entertainment, dining, etc.), a merchant or advertiser name or identifier, a transaction location (e.g., zip or postal code, city, etc.), a spend amount, a total spend amount for a given time period, an average spend amount for a given time period, a total number of transactions in a given time period, etc. Generally synonymous with segment delimiting information or segment criteria.

Dynamic Resegmentation: process of automatically delivering follow-up TMOs to consumers who redeem original or initial TMOs.

Financial Institution: an entity that provides banking or other financial-related services to consumers (customers) and, in connection with the disclosed invention(s), offers online banking capabilities to its customers, such entities including but not limited to: banks, credit unions, credit card companies, brokerage institutions, lending institutions, savings & loans, etc. In order to utilize aspects of the claimed invention(s), a financial institution will generally include and/or operate or control a financial institution computer system that enables the various functions of the financial institution, wherein the financial institution computer system includes, among other system components, a financial institution portal, a financial institution transaction processor, and a financial institution web server. Generally synonymous with bank.

Financial Institution Portal: a secure and individually-accessible online portal delivered via the Internet or a mobile application (i.e., having a GUI and/or other controls for use by consumers) that displays information related one or more accounts held by a consumer with a respective financial institution. Generally, a financial institution portal is Internet-accessible via a financial institution webpage or the financial institution mobile application, and displays prior financial transactions associated with the consumer's account(s), as well as TMOs and subsequent redemptions of those TMO. Information associated with financial institution portals (e.g., transactions, TMOs, etc.) is also generally accessible via consumer mobile devices (i.e., through wireless Internet connections, mobile banking applications, SMS alerts, etc.), email notifications, and other similar mechanisms. Generally synonymous with banking portal.

Financial Institution Transaction Processor: server or processor within a financial institution that receives and stores consumer transaction data from merchants, and, in accordance with aspects of the claimed invention(s), de-identifies such transaction data to remove consumer- and/or account-specific information, transmits de-identified consumer transaction data to the OPS for offer matching purposes, issues redemptions/rewards to consumers, and performs other similar functions as described herein. Generally synonymous with financial institution transaction system.

Financial Institution Web Server: a computer server within a financial institution for serving financial institution content, such as web pages, transaction data, TMOs, redemptions/rewards, and other similar content to consumers via a financial institution portal. Generally enables communication and data sharing between internal components of the financial institution (e.g., financial institution transaction processor) and components of the TMS. In accordance with aspects of the invention, a financial institution web server provides and operates a corresponding and associated financial institution portal.

Identity Assurance Rating: a percentage-based measure of the likelihood that a given unidentified merchant name extracted from consumer transaction data is associated with or represents a known or validated merchant within the TMS as a result of a merchant identification process. Generally synonymous with identity assurance score.

Impression: an occurrence or instance of a consumer logging in to his or her financial institution portal, whereby a particular TMO is displayed to (and/or viewed by) the consumer. Generally synonymous with offer impression.

Matched Offer Table: a data table or file in the TMS associating information relating to particular TMOs that have been matched to specific consumer transactions or specific OTEs (OTEs) and may be delivered to the consumers that completed the specific transactions or OTEs, including but not limited to: a transaction identifier, an OTE identifier, an offer identifier, an account global unique identifier of the consumer account, etc.

Merchant: an entity that provides or sells goods and/or services to consumers. As used herein, generally comprises an entity that provides or sells competing or related goods and/or services to those of an advertiser.

Merchant Category: a predetermined grouping of merchants based on the specific nature of the merchants' business(s) and/or service(s). Generally, each merchant associated with the TMS belongs to one or more merchant categories. Merchant categories generally serve as optional dimensions used by advertisers to define TCSs during generation of TMCs.

Merchant Identification Table: a data table or file in the TMS associating information relating to unidentified merchant names which have been analyzed via the merchant identification process and associated with known or validated merchants recognized by the TMS, including but not limited to: an unidentified merchant key, an unidentified merchant name, a validated merchant key, a validated merchant name, a merchant category, an identity assurance rating, etc.

Offer, see targeted marketing offer (TMO).

Offer Defining Information: information associated with a TMO that limits or defines the TMO, including but not limited to: an offer identifier, an offer amount, an offer start date, an offer end date, offer text, an offer image (e.g., a logo or trademark), a minimum qualifying spend amount, etc. Generally synonymous with offer specifics, offer terms or terms of offer.

Offer Impression Table: a data table or file in the TMS associating information indicating that a particular TMO was actually delivered to (and/or viewed by) a particular consumer, including but not limited to: an offer identifier, an account global unique identifier, a date of impression, a time of impression, etc.

Offer Management System (“OMS”): component of the TMS that enables creation of TMCs, TCSs, and TMOs, reporting of marketing data and campaign results to advertisers, transmission of data to and receipt of data from one or more OPSs, and other similar processes as described herein. Generally includes one or more databases, memories, servers, computer readable media, processors, algorithms, portals, and other similar components.

Offer Placement System (OPS): component of the TMS that enables matching of received campaign data from the OMS with de-identified consumer transaction data from financial institutions, injecting or merging TMOs into financial institution portals, organizing and transmitting redemption data to financial institutions for reimbursements to consumers, transmission of data to and receipt of data from the OMS, and other similar processes as described herein. Generally includes one or more databases, memories, servers, computer readable media, processors, algorithms, and other similar components.

Offer-Qualifying Purchase (“OQP” in the singular or “QOPs” in the plural): a transaction or purchase by a consumer that may be eligible (qualify) to receive a TMO, once processed by a system constructed as described herein. Generally synonymous with offer-qualifying transaction.

Offer Redemption Payment: a value provided to a consumer or credited to a consumer's account based on the consumer's redemption of a particular TMO, including but not limited to: financial payment, cash back, account credit, account points, airline miles, hotel points, restaurant points, and other similar incentives. As used herein, an ORP is not necessarily a “payment” in the sense of money or funds, and should thus be understood as generally synonymous with reward.

Offer Redemption Table: a data table or file in the TMS associating information indicating that a particular TMO delivered to a particular consumer was acted upon (i.e., redeemed), including but not limited to: an offer identifier, an account global unique identifier, a date of redemption, a time of redemption, etc.

Offer Table: a data table or file in the TMS associating information relating to the content of particular TMOs for delivery to selected consumers, including but not limited to: an offer identifier, a campaign identifier, a segment identifier, an offer amount, an offer start date, an offer end date, offer text, an offer image (e.g., a logo or trademark), a minimum qualifying spend amount, etc.

Offer-Triggering Event (OTE): an event or series of events that, if satisfied, dictate that an offer or advertisement should be provided to a consumer, including but not limited to: an OQP, satisfaction of a TCS or some other merchant-defined criteria, modeled event, conduction of an online financial institution portal session by a consumer, etc. Generally, an OTE comprises satisfaction of a predefined category or set of criteria identifying how a consumer spends (or does not spend) money, typically based on each consumer's transaction history (e.g., types of merchants at which a consumer typically shops, types of merchants at which a consumer rarely shops, average number of transactions completed by a consumer for a given month, average spend amount (dollar value) of a consumer's transactions, geographic locations in which a consumer typically shops, etc.).

OMS Advertiser Portal: an online, secure, individually-accessible portal (i.e., GUI) used by advertisers, advertising agencies, and other similar entities to create TMCs, TCSs, and TMOs, review previously-created campaigns, segments, and TMOs, review and analyze reports and statistics related to performance of particular campaigns, conduct billing operations, and carry out other similar tasks.

Redemption: realization of a TMO by a consumer via a RQP.

Redemption-Qualifying Purchase (RQP): a transaction or purchase by a consumer that satisfies the associated criteria of at least one TMO, and thereby qualifies the consumer for a reward. Generally, but not always, associated with the same account with which the OQP or OTE occurred. Generally synonymous with redemption-qualifying transaction.

Reverse Proxy: a security component, often used by financial institution computer systems, that provides a layer of security to each financial institution's local area network LAN in addition to the financial institution's firewall(s). Generally includes computers and/or processors acting as proxy servers to intercept, inspect, and (if necessary) redirect inbound and outbound communications between components on either side of the reverse proxy. Generally used in association with financial institution security protocols, for example, to handle Secure Sockets Layer (SSL) encryption often used between a consumer's computer and a financial institution web server, caching of content, load balancing, performance acceleration, and for other reasons understood by those skilled in the art.

Segment: see TCS.

Segment Delimiting Information: see dimension.

Segment Table: a data table or file in the TMS associating information used to identify a particular segment of consumers based on transactions completed by those consumers, including but not limited to: a segment identifier, a campaign identifier, a merchant or advertiser category (e.g., retail, entertainment, dining, etc.), a merchant or advertiser name or identifier, a transaction location (e.g., zip or postal code, city, etc.), a spend amount, etc.

Targeted Consumer Segment (TCS): a group of consumers to which at least one TMO applies based on the specifics of the TMO(s) and one or more offer-qualifying transactions or OTEs (OTEs) completed by each consumer. Generally a subset of the entire population of available consumers. Generally synonymous with segment and market segment.

Targeted Marketing Campaign (TMC): a marketing campaign constructed by an advertiser, advertising agency, or other entity designed to generate and place advertisements in the form of TMOs and display such TMOs to consumers via the consumers' online financial institution portals. Generally includes one or more TCSs and one or more TMOs. Generally synonymous with campaign.

Targeted Marketing Offer (TMO): an offer to deliver a particular reward, refund, financial payment, offer redemption payment, or other incentive to a consumer via a system constructed as described herein, in response to the consumer satisfying certain requirements of the offer, e.g., purchase of goods or services in accordance with the offer, provision of requested information, or other required action or condition satisfaction. Generally, each TMO is associated with a corresponding TCS. As described herein, TMOs are presented to consumers during the consumers' online banking sessions via each consumer's financial institution portal. Generally synonymous with offer or advertisement.

Targeted Marketing System (TMS): overall system as described herein for creating TMCs, delivering those campaigns to consumers via financial institution portals, tracking consumer redemption of TMOs, reporting campaign results, maintaining privacy and security amongst financial institution clients (i.e., consumers), and performing a host of other tasks and processes as described in detail herein. Generally includes an OMS, one or more OPSs, and other additional components as described herein.

Transaction Table: see consumer transaction table and de-identified consumer transaction table.

Unidentified Merchant Key: a unique identifier assigned to each unidentified merchant name within the TMS.

Unidentified Merchant Name: a merchant name extracted from consumer transaction data and transmitted to the OMS for identification and association with a recognized or validated merchant within the TMS.

Validated Merchant Key: a unique identifier assigned to each validated merchant name that has been associated with a recognized merchant within the TMS based on completion of the merchant identification process.

Validated Merchant Name: an accepted or recognized name (and all validated variations thereof) associated with a given merchant within the TMS. Generally, unidentified merchant names are associated with validated merchant names upon completion of the merchant identification process and the attainment of an identity assurance rating above a predefined threshold rating. Generally synonymous with cleansed merchant name.

Validated Merchant Table: a data table or file in the TMS associating information relating to merchant names that have been validated via the merchant identification process based on a calculated identity assurance rating above a predefined threshold rating, including but not limited to: an unidentified merchant key, an unidentified merchant name, a validated merchant key, a validated merchant name, a merchant category, an identity assurance rating, etc.

### Overview

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Aspects of the present disclosure generally relate to systems and methods for providing TMOs to consumers via financial institution portals, especially applicable but not limited to financial institution portals. Although the description which follows is primarily directed to application of the claimed invention(s) to financial institution portals, it should be understood that the invention(s) have broader applicability to any systems with portals that allow consumer viewing of predetermined information maintained by third parties on behalf of such consumers, especially those that relate to financial transactions, purchases, sales, or other commercial transactions that can be analyzed for purposes of generated TMOs based on such predetermined information.

A TMS, as described herein context of a financial institution portal, enables advertisers to construct highly-relevant advertisements and TMOs that are displayed to consumers as those consumers access and view their online financial institution account portals. The TMOs are generally targeted to specific consumers based on prior transactions or purchases made by the consumers, as well as patterns in those transactions and overall consumer spending habits.

However, based on aspects of embodiments of the TMS described in detail herein, advertisers have no knowledge of specific consumers nor any information relating to particular consumer transactions. Thus, embodiments of the TMS allow targeted advertising on a financial institution portal in a manner that protects all consumer data and privacy, and is compliant with the highly-complex banking and financial institution regulatory environment.

Additionally, embodiments of the TMS, via cooperation with one or more financial institutions, further enable accurate and automatic redemption or realization of TMOs when consumers make RQPs. Further aspects of the present systems and methods facilitate reporting and analytics to advertisers regarding consumer interaction with and redemption of TMOs, collection of de-identified financial transaction data for advertiser use in targeted marketing campaign creation, and a host of other functions and processes as are described in detail herein.

According to one embodiment, a TMS includes an OMS and one or more OPSs, wherein each OPS operates in association or cooperation with a financial institution's online services system (i.e., online environment or mobile application), including a financial institution transaction processor and financial institution web server, thereby providing a financial institution portal.

Generally, the OMS enables creation of TMCs by advertisers, reporting of marketing data and campaign results to advertisers, collecting redemption funds from advertisers and distributing those funds to financial institutions, and other processes described in greater detail below.

Generally, operations of an OPS include matching received campaign data from the OMS with de-identified consumer transaction data received from financial institutions, injecting or merging TMOs into financial institution portals, sending targeted marketing campaign performance data to the OMS, organizing and transmitting redemption data to financial institutions for reimbursements to consumers, and other processes described in greater detail below.

In one embodiment, “de-identified” transaction data (i.e., transaction data void of any consumer- or account-specific identifying information) is sent to an OPS by a respective financial institution. Typically, at least one virtual or physical OPS is in operative association with each participating financial institution to allow direct communication between each OPS and its respective financial institution. Generally, the transaction data is de-identified by each financial institution according to the institution's own internal protocols and procedure for removing account information and other consumer-identifying information. Each OPS stores this information for subsequent offer matching. Additionally, each OPS collects the de-identified consumer transaction information and makes such information available to the OMS for use in campaign creation. When needed, the OMS requests and accesses this transaction data and utilizes it during campaign creation to estimate potential populations of consumers that will receive TMOs associated with campaigns, and other similar uses. During campaign creation, advertisers that wish to provide TMOs, may interact with an OMS advertiser portal that displays campaign specifics, enables creation of targeted marketing segments and TMOs, allows advertisers to define dimensions and specific criteria associated with each segment and TMO, etc.

Once a campaign (and its associated TMOs has been created, the OMS transmits the campaign data to each OPS for merging with transaction data and delivery to consumers. According to one embodiment, each OPS, via a predetermined matching algorithm, matches specific consumer financial transactions with TMOs that satisfy the segment dimensions associated with the TMOs. According to another embodiment, rather than being matched to specific transactions, TMOs are matched to consumers' OTEs, such as a pattern or series of transactions that meet a certain set of segment dimensions. After each offer-qualifying transaction or other OTE has been matched with a respective TMOs or TMOs, the TMOs are displayed to consumers via each consumer's online financial institution portal. Thus, when a consumer logs in to his or her financial institution portal, he or she is presented with TMOs that are targeted to prior transactions or purchases made by the consumer. For example, the TMOs may be directed at transactions involving competitors of the advertiser that created the respective marketing campaign (although this is not always the case).

In one embodiment, a consumer redeems a TMO by making a RQP using a payment mechanism (e.g., a debit card or credit card) associated with the respective financial institution account to which the TMO was originally related. The RQP is subsequently recorded by the financial institution and is transmitted to the OPS associated with that institution. The OPS then examines each received de-identified transaction to determine if it qualifies as an RQP associated with a TMO previously presented to and received by the consumer. Once verified as an RQP, the OPS records and stores the instance of the RQP (e.g., within its respective offer redemption table, discussed below) for subsequent processing. For example, the OPS determines the associated reward to be paid to the consumer by converting the reward value of the TMO from dollars (as it is typically originally entered by an advertiser within an OMS portal when the TMO is created, discussed below) to the appropriate rewards type (e.g., points, miles, etc.) associated with the consumer account that completed the RQP. Subsequently, the OPS provides a visual indication to the consumer in the financial institution portal that the purchase qualified for a redemption based on the previous TMO.

At predetermined time intervals (e.g., daily, weekly, monthly) or continuously or on request, each OPS provides notification to its associated financial institution as to the sum of all offer redemption payments to be credited to each consumer's account. The sum of the ORPs associated with each particular targeted marketing offer (TMO) or campaign is determined by each OPS and transmitted to the OMS for storage (e.g., within its campaign results table, discussed below) and subsequent processing. At predetermined time intervals or continuously or on request, advertisers issue payments to financial institutions (e.g., by depositing or transferring funds to the OMS for transmission to each OPS for payment to financial institutions) for reimbursement of the ORPs yielded from their respective TMOs based on rewards issued to consumers. After the completion of a targeted marketing campaign (or during its operation), advertisers are able to view results and performance data associated with the campaign via an OMS portal.

### Description of TMS, Components, and Processes

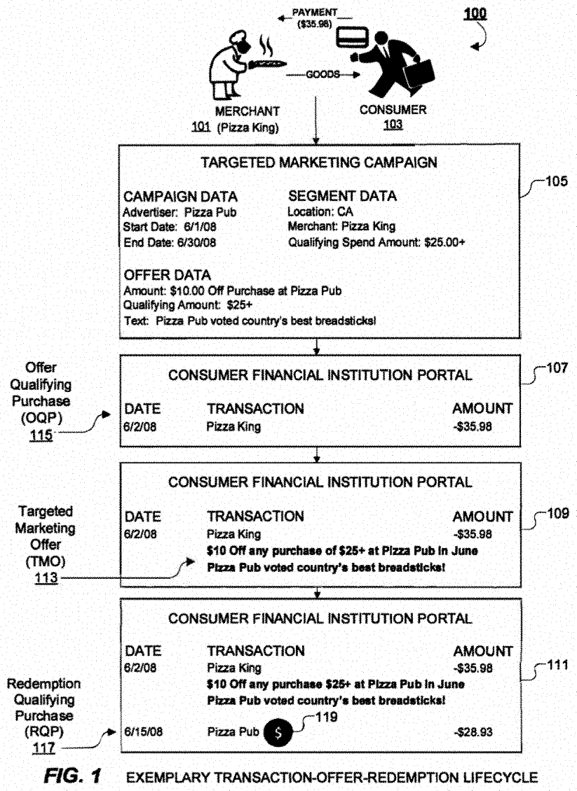

For purposes of example and explanation of the fundamental processes and components of the disclosed systems and methods, reference is made to FIG. 1, which depicts a high-level lifecycle 100 of an exemplary transaction, an associated TMO, and redemption of that TMO according to one embodiment of a TMS constructed and operated in accordance with various aspects of the claimed invention(s). As will be understood and appreciated, the example lifecycle shown in FIG. 1 represents merely one approach or embodiment of the present system, and other aspects (e.g., delivery and/or redemption of TMOs based not on singular transactions, but on a series or pattern of transactions) are used according to various embodiments of the present system.

As shown in the lifecycle 100, a process for TMO delivery commences with a purchase from or financial transaction with a merchant 101 (e.g., hypothetical advertiser competitor Pizza King) by a consumer 103. As defined elsewhere herein, an “advertiser” describes an entity that creates a targeted marketing campaign associated with its goods and/or services, whereas a “merchant” or “advertiser competitor” is an entity that sells competing and/or related goods and/or services to those of the advertiser. The terms “advertiser”, “merchant”, and “advertiser competitor” are used herein for purposes of discussion and explanation only, and, as will be understood and appreciated, are not intended to define or limit a particular class of entities. For example, an advertiser may fulfill roles as both an advertiser and a merchant, wherein the advertiser creates marketing campaigns targeted to consumers, and is also the subject of its competitors' marketing campaigns (and vice versa). Thus, for practical purposes, advertisers and merchants are interchangeable. For purposes of discussion and ease of reference, however, advertisers are referred to herein as those that create marketing campaigns, and merchants (or advertiser competitors) are those that provide competing or related goods and/or services to those of advertisers.

In the example shown in FIG. 1, at some point in time, an advertiser (in this example Pizza Pub, not the merchant Pizza King 101) generates a TMC associated with its goods and/or services (block 105). In one embodiment, the campaign is created via an OMS advertiser portal within the TMS, as described elsewhere herein. Generally, advertisers define campaign specifics, such as the start and end date of a campaign, segments of consumers that the campaign will target (based on physical location of consumer purchases, spend amounts, etc.), specific TMOs amounts, texts, logos associated with campaign TMOs, and various other predetermined campaign criteria (discussed in greater detail below).

As shown in block 105, the exemplary campaign has been generated by an advertiser (e.g., “Pizza Pub”), and is scheduled to run between Jun. 1, 2008 and Jun. 30, 2008. Thus, any consumer transactions occurring within those dates may be subject to this specific campaign. The exemplary campaign also defines a particular consumer transaction segment (i.e., transactions occurring in California at advertiser competitor “Pizza King” locations, wherein the transaction is for an amount greater than $25). The representative campaign shown in block 105 also includes a TMO to be presented to consumers, wherein a consumer is offered $10 off the price of any purchase of $25 or more at a Pizza Pub in June, and includes the advertiser-defined text: “Pizza Pub voted country's best breadsticks!”. As will be understood and appreciated, the campaign criteria shown in block 105 are presented for illustrative purposes only, and are in no way intended to limit the scope of campaign specifics and dimensions available to advertisers for campaign creation.

According to one embodiment, the TMS gathers all advertiser TMOs centrally, and then displays those TMOs with corresponding consumer transactions via a consumer's financial institution portal. In one aspect, if a transaction, group of transactions, or other OTE meets the criteria of one of the TMOs defined in a campaign, then that TMO is associated with the transaction, group of transactions, or OTE, and is displayed to a consumer via the consumer's financial institution portal (assuming there are no competing TMOs that could also apply to the transaction(s) or OTE, in which case a ranking algorithm may be utilized to determine which TMO(s) are displayed). Generally, each campaign includes one or more TMOs of which each is presented to one or more TCSs as defined by the advertiser. As will be understood and appreciated, each campaign may include a plurality of segments and TMOs, depending on the given advertiser's preferences. Further, each TMO and segment may include a variety of criteria or dimensions that define the scope of each.

As shown in block 107, a consumer 103 purchases a pizza (or pizza-related items) from a merchant 101 (e.g., Pizza King) of an advertiser (e.g., Pizza Pub). The purchase is represented in block 107, which is a representation of the transaction as shown in the consumer's conventional financial institution portal (i.e., with no TMO displayed). The purchase shown in block 107 is a representative OQP 115 (discussed in greater detail below). Generally, the consumer 103 is able to view a plurality of recent, prior transactions or purchases associated with one or more of the consumer's accounts via an interactive and scrollable webpage or mobile application associated with an online financial institution portal. As shown, the exemplary purchase occurred on Jun. 2, 2008, at Pizza King, and was for the amount of $35.98. This representative and exemplary transaction is referenced throughout this disclosure for discussion purposes.

As will be understood by one of ordinary skill in the art, when a purchase is made by a consumer via some mechanism associated with a consumer account (e.g., credit card, debit card, paper check, etc.), that transaction is recorded by the respective financial institution and made available for online viewing within the consumer's financial institution portal. The portal typically displays a plurality of financial transactions, each transaction including transaction-specific information such as the transaction date, purchase amount, merchant, etc. Thus, while only one transaction is shown in block 107, it will be understood that many transactions are typically displayed in consumer financial institution portals. Additionally, according to various embodiments of the present system, if a transaction qualifies for receipt of an TMO, then the TMO will be displayed in relative juxtaposition with the transaction in the consumer's financial institution portal (as discussed below in association with block 109). Thus, the conventional portal display represented by block 107 is presented for illustrative purposes only.

Still referring to FIG. 1, block 109 is a representation of the consumer's financial institution portal with the TMO 113 displayed in perceptible association or juxtaposition with the consumer transaction that, in this example, triggered the presentation of the TMO, e.g. the OQP 115. In one embodiment of the TMS, transactions are matched with TMOs by a matching algorithm within each OPS in a manner such that advertisers have no knowledge of specific consumers or their accounts that receive the TMOs (described in greater detail below). As shown in block 109, because the consumer's transaction satisfied the criteria (i.e., the “terms of offer” or “offer terms”) defined in the campaign for the specific TMO 113 (i.e., purchase within the start and end date of the campaign, at Pizza King, for an amount greater than $25, etc.), the consumer 103 was presented with the respective TMO. As shown, the TMO 113 indicates that if the consumer 103 makes any purchases (via a payment mechanism associated with the particular financial institution account) at a Pizza Pub (i.e., advertiser) of greater than $25 in the month of June, the consumer will receive $10 off of that purchase.

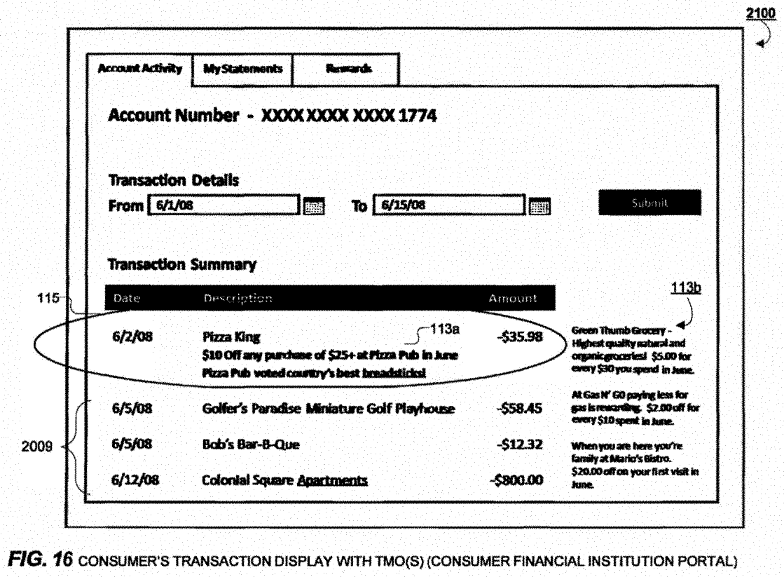

In an alternate embodiment, rather than displaying a TMO in juxtaposition with a specific transaction, the TMO is displayed as a banner advertisement or pop-up advertisement, or inside an advertising widget on the financial institution's portal, or on a separate offer(s) page, or via some other similar display mechanism (see, e.g., FIG. 16). Further, some TMOs are triggered not by a single, specific transaction, but rather by an OTE, such as an accumulation of a consumer's transactions over time that satisfy a predefined segment based on average spend amounts at a given merchant or merchant type, or something similar. Accordingly, these TMOs are generally related to a consumer's purchase history or spending habits, and not to particular transactions, and are thus generally displayed in a consumer's financial institution portal.

As will be apparent, the specific and exemplary TMO 113 shown in FIG. 1 is an attempt by the advertiser (i.e., Pizza Pub) to attract consumers from one of its competitors 101 (i.e., Pizza King). Because the consumer 103 made a purchase at a Pizza King previously, the advertiser can infer that the consumer has a propensity to buy pizzas or pizza-related items. Thus, according to one aspect, TMOs within embodiments of the TMS are highly targeted because they are provided to consumers that already have an interest in the particular type or category of goods and/or services provided by the advertiser, or might be interested in related goods or services to those of an advertiser. As will be understood, however, TMOs do not have to be targeted to advertiser competitors, but instead could be targeted to consumers who already shop with a given advertiser for purposes of increasing business volume. For example, the advertiser could reward consumers and generate loyalty by offering frequent customers additional incentives to shop with the advertiser. TMOs may also be targeted to related product areas that often go hand-in-hand with the advertiser's products or services (e.g., a golf sporting goods store targeting offers to consumers who made purchases at a golf course). Or, TMOs may be targeted to broad categories, such as consumers who shop at luxury stores, or consumers who rarely buy fast food items, etc. In general, regardless of the form of the TMOs, they are typically highly relevant because they are targeted based on how a consumer already spends money.

As will be understood and appreciated, a virtually unlimited number of financial institutions may utilize aspects of the present systems and methods. Accordingly, in one embodiment, TMO presentation and display is customized to match the overall look and feel of each institution's online banking environment. As shown in block 109, the TMO 113 is presented in perceptible association or operative juxtaposition with the prior transaction to which the TMO was matched (i.e., the TMO is presented in relative proximity to its associated transaction). As will be understood, the TMO may be displayed according to a variety of presentation forms, such as in an account summary, account overview, immediately under the prior transaction (as shown in block 109), indented under the transaction, in a contrasting type, font, or color as compared to the transaction, etc. If the TMO is matched not to a single transaction, but to an OTE, then the TMO may be displayed in a more general display manner (e.g., via a pop-up or banner advertisement), although not necessarily. Regardless, when a consumer 103 logs into his or her portal, he or she will see a TMO associated with each transaction or OTE that has criteria matching a potential TMO (assuming at least one of the consumer's transactions can be matched to a TMO).

In some circumstances, the consumer 103 may be presented with multiple TMOs corresponding to multiple transactions. In other circumstances, no TMOs will be presented because the consumer 103 made no recent purchases or satisfied any OTEs that match offer criteria of any potential TMOs. Additionally, in one embodiment, the presentation of TMOs complies with guidelines established by each financial institution (e.g., number of TMOs allowed per display page, format of TMOs, location of TMOs, etc.). As will be understood, while the TMO 113 is shown listed in block 109 immediately underneath the corresponding transaction, TMOs may be presented in any number of ways, such as by account overview advertising widget, pop-up advertisements, listing of TMOs in a separate section of the financial institution portal display, and via other similar display formats (provided that consumers are able to perceive and subsequently redeem the offers).

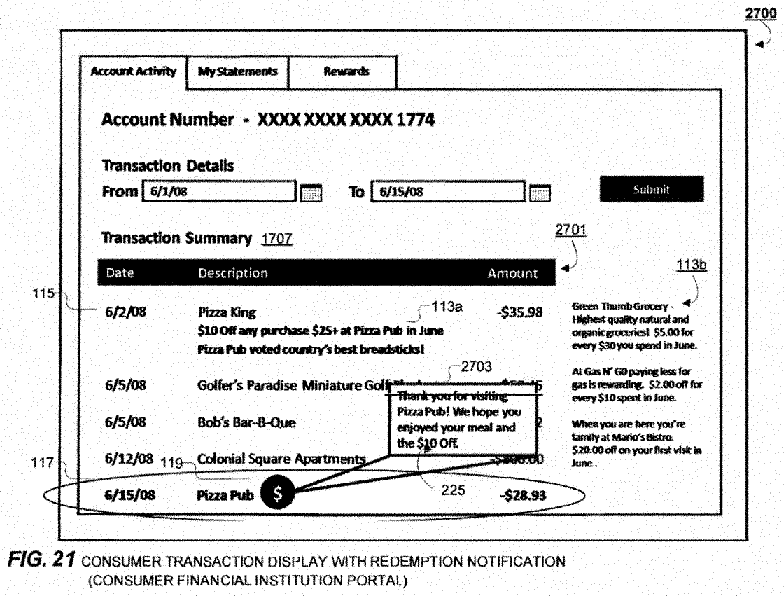

Still referring to FIG. 1, according to one embodiment, if a consumer 103 decides to redeem (i.e., accept or respond to) a TMO as shown in 109, the consumer is merely required to satisfy the TMO criteria, and the TMS instructs the financial institution to credit the TMO redemption value (i.e., reward) to the consumer's account or provide the reward to the consumer via some other appropriate reward mechanism. As shown in block 111 of the example lifecycle 100, the consumer made a RQP 117 at an advertiser location (i.e., Pizza Pub) on Jun. 15, 2008 for $28.93. Because this purchase fell within the advertiser-defined TMO criteria (i.e., in June, at a Pizza Pub, greater than $25, etc.), the TMS automatically detected the transaction as an RQP 117, and thus instructed the financial institution to credit the consumer's account accordingly (discussed in greater detail below). Next to the transaction is an RQP icon 119 (shown and discussed in greater detail in conjunction with FIG. 21) indicating to the consumer 103 that he or she redeemed a previously-presented TMO 113, and thus received a reward for the subject purchase.

In one embodiment, when the consumer 103 clicks on the icon 119 via a cursor (i.e., “mouse”), or simply hovers the cursor over the icon (i.e., “mouse over”), or interacts with the icon in some other understood manner, the financial institution portal displays information relating to the reward received by the consumer. As will be understood and appreciated, the reward may be indicated to the consumer 103 in a variety of ways, such as via a separate line item in the financial institution portal, an email notification, etc. Therefore, embodiments of the present TMS are in no way limited to use of an RQP icon 119 to indicate redemption payments or rewards.

As will be appreciated, all participatory parties benefit from use of embodiments of the TMS. Advertisers are given access to new, digital marketing channels with large consumer populations. Embodiments of the TMSenable advertisers to provide highly-targeted advertisements and TMOs to consumers based on how those consumers already spend money. Advertisers are also provided with data and reports related to the effectiveness of their TMOs and advertising campaigns via continually-collected and recorded offer impression and redemption data. Additionally, banks and other financial institutions benefit by being able to offer their customers an additional outlet to accumulate rewards currency in the form in which their account(s) are currently enrolled. Such reward currencies drive customer loyalty and use of specific accounts, increase consumer transactions, and reduce attrition. For example, as consumers redeem TMOs, they build their rewards (e.g., airline miles, hotel points, cash back, etc.), and thus the consumers are more likely to continue using payment mechanisms (i.e., credit cards, debit cards, etc.) associated with the specific financial institution account. Finally, consumers benefit from embodiments of the present systems and methods because they receive cash and rewards merely by purchasing items they typically already purchase.

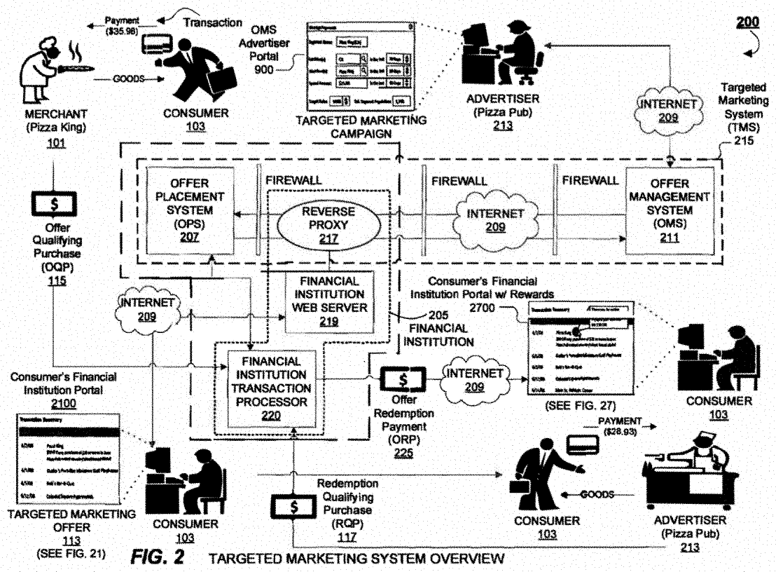

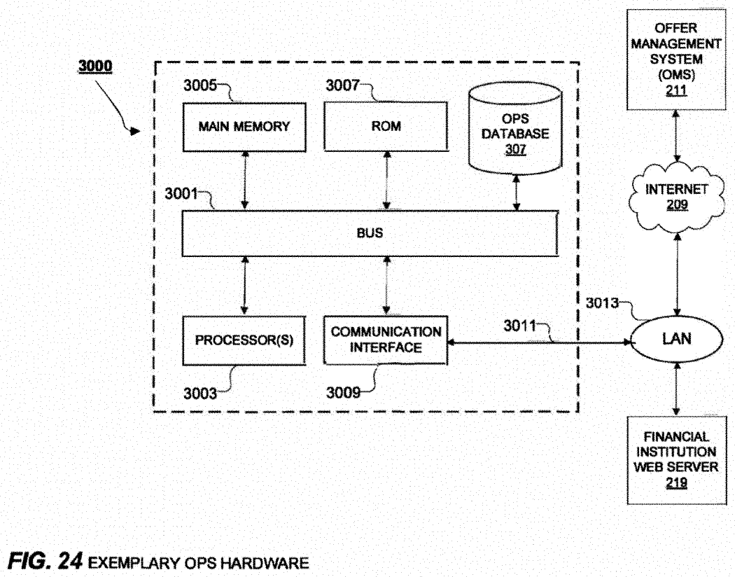

Referring now to FIG. 2, a high-level overview 200 is shown of one embodiment of the TMS 215 and its associated environment. As shown, the TMS 215 includes an OMS 211 remotely connected (although the connection does not necessarily have to be remote) to one or more OPSs 207 via the Internet 209. Generally, the OMS 211 enables creation of TMC, segments, and TMOs by advertisers, reporting of marketing data and campaign results to advertisers, transmission of data to and from one or more OPS's 207, and other similar processes described herein. Generally, the OPS 207 enables matching of received campaign data from the OMS 211 with de-identified consumer transaction data received from financial institutions, injecting or merging TMOs into financial institution portals, organizing and transmitting redemption data to financial institutions for reimbursements to consumers, transmission of data to and from the OMS, and other similar processes described herein. Although the OMS 211 and OPS 207 are represented in FIG. 2 as conceptual boxes, in one embodiment, both the OMS and each OPS comprise system components including one or more databases, memories, servers, computer readable media, processors, algorithms, portals, and other similar components (see FIGS. 23-24 for further description of OMS and OPS hardware).

In the embodiment shown in FIG. 2, in addition to being remotely connected to the OMS 211, the OPS 207 is directly connected to a financial institution system 205 to enable direct and secure communication of information back and forth between the OPS and financial institution, as the OPS is protected behind the financial institution's existing firewall(s). As will be understood and appreciated, the financial institution may be a bank, credit card company, lending institution, savings & loan, prepaid debit company, or other similar financial institution. Additionally, although the embodiment of the TMS 215 shown in FIG. 2 includes only one OPS 207 and one financial institution system 205, other embodiments of the TMS include many OPS's connected to many different financial institutions. Generally, one OMS is capable of servicing a plurality of OPS's at a plurality of financial institutions. Further, according to one aspect, more than one OPS 207 is connected to each financial institution 205. For example, an embodiment of the present system may be constructed such that a different OPS services each different aspect of a financial institution's services (e.g., credit card account, bank account, money market account, stock brokerage needs, web services, transaction processes, etc.), or synchronized OPS's may reside in multiple data centers that serve customers to improve scalability and reliability. For ease of reference, however, the figures and discussion of the present disclosure are primarily directed to an exemplary system comprising only one financial institution 205 and one OPS 207.

Generally, most financial institutions employ a distributed architecture in which different entities within each financial institution may be located at different physical or virtual locations, and perform different services and functions for the overall financial institution system. Thus, the exemplary financial institution 205 shown in FIG. 1 illustrates two components-a financial institution web server 219 and a financial institution transaction processor 220. The functions of the web server 219 generally include, among other things, serving the financial institution portal (and its associated web pages, data, and other content) to consumers 103. The functions of the financial institution transaction processor 220 include, among other things, tracking and storing consumer transactions data for subsequent use. The functions of each of these illustrated components 219 and 220 and their interaction with various OPS components is described in greater detail throughout this disclosure. Additionally, although most financial institutions include at least these two discrete components 219, 220, financial institution systems 205 are referred to generally in various parts of this disclosure for ease of reference.

According to the embodiment shown, all information or data passing between the OMS 211 and the OPS 207 is processed via a reverse proxy 217, typically in conjunction with (but sometimes alternatively to) a DMZ, before the data is allowed to proceed (described in greater detail below). In one embodiment, the OPS 207 is directly connected to the financial institution system 205 in a manner such that various components of the OPS operate behind the financial institution firewall(s) and other security protections. Accordingly, in order to preserve the security of the overall system, ensure secure communications (e.g. via SSL), prevent system corruption, and retain consumer privacy, all data and information passing into or out of the OPS is processed within a reverse proxy located on the financial institution's web server 219 or similar equally secure means. Generally, embodiments of the reverse proxy 217 used within aspects of the present system comprise computers and/or processors acting as proxy servers to intercept and inspect all inbound and outbound communications between components on either side of the reverse proxy. When the reverse proxy identifies information being sent to or from the OMS 211 to the OPS 207, the reverse proxy directs the information via the web server 219 to the OPS over the financial institution's internal network. Typically, the reverse proxy 117 (and/or DMZ) checks file types and formats, verifies that certain information or types of information is or is not present in the transmitted data, and performs other operations as described in greater detail below. Generally, each financial institution 205 defines the specifics and protocols associated with its respective reverse proxy 117 and/or DMZ, and thus data transmitted between each OPS 207 and the OMS 211 should comply with these protocols.

As shown in FIG. 2, an advertiser 213 (i.e., Pizza Pub) or targeting model generates a TMC within the OMS 211 via an OMS advertiser portal 900. Before a campaign is created, de-identified consumer transaction data is transmitted from the financial institution's transaction processor 220 to the OPS 207, which stores the data for subsequent use. This data is collected by the OPS and accessed by the OMS as needed for campaign generation. The financial or consumer transaction data is de-identified of any consumer- or account-identifying information via an internal financial institution de-identifying process and stored in a de-identified consumer transaction table. Each financial institution 205 that is connected to and utilizes aspects of the TMS 215 employs its own protocol for removing identifying information from consumer financial transactions. Such identifying information is removed to protect consumer privacy, maintain security, etc. Thus, the transactions data received by each OPS includes a plurality of financial transactions indicating merchants involved in the transactions, merchant types, spend amounts, dates, payment mechanism types, and other similar information. However, the information does not include specific consumer names, account numbers, or other identifying information.

The de-identified financial transaction data is collected in the OPS 211, and accessed by the OMS for use in generation of TMCs and associated TMOs 113. Generally, a TMC is an advertising campaign constructed by an advertiser 213, advertising agency, or other entity designed to generate and place advertisements in the form of TMOs and display such TMOs to consumers 103 via the consumers' online financial institution portals. Each TMC typically includes one or more TMOs 113 related to the overall theme of the TMC. As an advertiser 213 creates a campaign and groups consumers into TCSs, the transaction data provides an accurate estimate as to the number of consumers each TMO will reach based on the most recent de-identified consumer transaction data available across all OPS's in the TMS 215. Thus, the advertiser 213 is able to modify the specifics of each TMO based on the size of the projected consumer segment associated with each TMO (discussed in greater detail below).

Typically, the TMOs presented to consumers 103 within embodiments of the present TMS 215 are targeted based on purchases made by each consumer and related information associated with those purchase. When an advertiser 213 creates a TMO, the advertiser typically defines a segment of consumers that will receive the TMO based on one or more transactions completed by the consumers. For example, an advertiser 213 may target a TMO to consumers who spent a certain amount of money at a particular retailer during a given time period in a defined zip code. Advertisers can identify, based on aggregated consumer transaction data, approximately how many consumers the TMO will reach. The advertisers, however, are unaware of any specific consumers that actually receive or redeem the presented TMOs, as the advertisers are never given any specific consumer-identifying information.

Once a campaign, and its associated TMOs, is finalized by the advertiser 213 or targeting model, the TMOs are stored in the OMS 211, transmitted to each OPS 207 via each corresponding reverse proxy 217 (and/or DMZ), and then matched with actual consumer transactions or OTEs that satisfy the offer criteria. The resulting matched offers are stored in the corresponding OPS for potential delivery to consumers. As each consumer 103 logs in to his or her specific account(s) via the respective online financial institution portal, the matched offers corresponding to transactions or OTEs are injected or merged into the graphical display of the consumer's financial institution portal, thus transforming the conventional financial institution portal display into one that includes one or more TMOs (described in greater detail below).

In the example overview 200 shown in FIG. 2, a consumer 103 engages in a transaction with a merchant 101 (i.e., advertiser competitor Pizza King). For ease of reference, this transaction corresponds to the exemplary transaction discussed in association with FIG. 1 and in other parts of this disclosure. Because this transaction satisfies one or more TMOs generated by an advertiser 213 via the OMS 211 (discussed in greater detail below), the transaction qualifies as an offer-qualifying purchase or pattern of offer qualifying purchases. 115. As will be understood and appreciated, this transaction may have taken place either before or after the TMO to which it will be matched was created. A record of the OQP 115 is transmitted from the merchant 101 to the financial institution (typically, via a payment mechanism processor, such as a credit card reader), and identified and recorded within the financial institution 205 (particularly, within the financial institution transaction processor system 220) in a financial institution database along with numerous other transactions of the respective consumer 103, as well as other consumers and clients of the financial institution. As will be understood and appreciated, in order for the financial institution to identify and record the transaction, the OQP is completed via a payment mechanism associated with one of the consumer's accounts held at the financial institution, such as a credit card, debit card, prepaid card, gift card, paper check, wire transfer, or other similar payment vehicle, and is thus viewable via the consumer's online financial institution portal.

After the OQP 115 been recorded within the financial institution database, all consumer-identifying information is removed from the OQP (i.e., it is de-identified), it is then transmitted to the OPS 207 for storage in an OPS database and potential matching with TMOs 113. As will be understood by one of ordinary skill in the art, the de-identified transactions may be transmitted to the OPS on a continual basis, or batch processed and transmitted once daily, or transmitted via some other similar recurring transmission method. According to one embodiment, upon receiving the de-identified transactions, the OPS transmits all un-identified “raw” merchant names (i.e., those that cannot be recognized within the OPS's current database) to the OMS 211 in order to be “cleansed,” categorized, and validated via a merchant identification process. Those merchant names that are successfully associated with an existing validated merchant are returned to the respective OPS and subsequently stored within the OPS. Alternatively, the process of Predict Merchant Model (14113) may be applied as explained below.

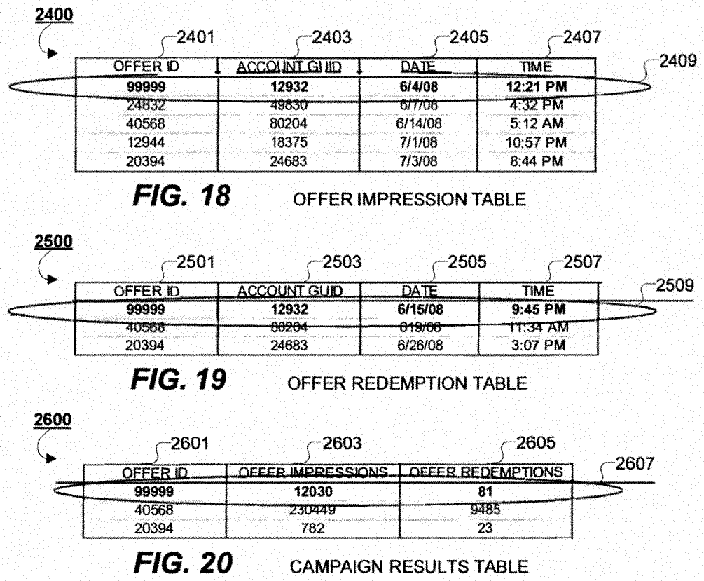

The OPS 207 then performs a matching process between received TMOs and received de-identified transactions to match TMOs to transactions that satisfy the criteria of the TMOs. After a TMO is matched to a particular transaction (or a particular consumer's account), identifiers associated with both the TMO and transaction (or account) are then stored in a matched offer table (see FIG. 18 and its associated discussion). According to one aspect, TMOs are matched to OTEs, such as groupings of transactions by a consumer, and such matches are stored in an OPS database. As will be appreciated, some consumer transactions will not satisfy any TMOs, and thus no TMO is matched to or displayed with these transactions in the consumer's financial institution portal.

Still referring to the exemplary embodiment of the TMS 215 shown in FIG. 2 and in accordance with aspects of the present systems and methods, when a consumer 103 logs into his or her financial institution portal after the OQP 115 has been matched to a TMO, the TMO 113 is displayed to the consumer in perceptible association with the OQP. In one embodiment, the TMS 215 utilizes a JavaScript document object model (DOM) injection to inject TMOs into the GUI associated with the financial institution portal when the interface is displayed to the consumer (discussed in greater detail below). Using this method, a relatively minimal amount of software code (typically, only a few lines of JavaScript code) are input into the financial institution's online environment (i.e., webpage-rendering software code at web server 219) that operates the financial institution's digital portal. When executed, this JavaScript code calls a separate algorithm stored within an OPS 207 that merges the TMOs with their corresponding transactions or OTEs in the rendered financial institution webpage. Although a preferred embodiment of the present system 215 utilizes a DOM injection to perform this merging process, other embodiments are not limited to this particular method, and other similar methods may be used.

It is understood that banks and other financial institutions are typically wary of modifying their systems to add functionality provided by a third party. This wariness stems from concerns about compromising the security of the bank and the effort required to make even minor changes to these complex systems. Thus, by utilizing a DOM injection at the point of display of the portal to the consumer 103, only a minimal amount of code is input into the financial institution's internal code, and advertisers 213 and other system operators of the TMS 215 have no access to the financial institution's code itself (or its data). Further, based on this minimally invasive insertion of a small amount of code into the financial institution's software, aspects of the TMS and financial institution system are able to operate independently of each other. Thus, if a problem occurs within the TMS, then the financial institution is able to operate in its conventional manner until the problem is rectified, and vice versa. Additionally, aspects of the TMS 215 may be updated or modified over time without requiring modification of the financial institution's software, as the TMS code that is written into the financial institution's software is merely a call to a larger code base stored within each OPS 207.

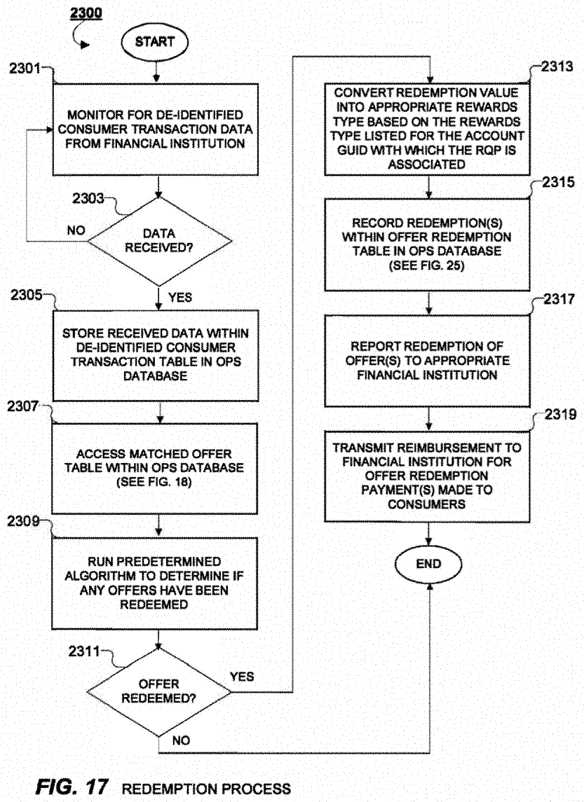

Still referring to FIG. 2, after a consumer 103 views a TMO 113 associated with the consumer's OQP 115, the consumer may elect to redeem the TMO according to the TMO specifics. As shown, the consumer 103 redeems the TMO 113 with the advertiser via a redemption qualifying purchase 117. The RQP, in this example, is a payment of $28.93 at an advertiser (i.e., Pizza Pub) location. For ease of reference, this RQP 117 corresponds to the exemplary RQP shown and discussed previously in conjunction with FIG. 1, and in other parts of this disclosure. A record of the RQP is transmitted to the financial institution 205 in much the same manner as the record of the OQP 115. Again, the financial institution records the OQP and transmits it to the OPS 207. In one embodiment, the OPS 207 then performs a redemption process to determine if the transaction completed by the consumer 103 satisfies any of the redemption criteria of the TMO(s) previously presented to the consumer (i.e., whether the transaction is in fact an OQP) (see FIG. 17 and its associated discussion for further details on this process).

If the consumer's transaction qualifies as a RQP 117 as stipulated by the TMO, then the OPS records the instance of that RQP within its respective offer redemption table and simultaneously calculates the type and amount of reward (i.e., ORP 225) earned by the consumer. In the presented example, the account to which the consumer's RQP was charged had been associated with a “cash back” rewards program (as shown subsequently in this disclosure), and thus no further conversion is needed (as the advertiser had entered the reward value of TMO(s) in dollars). In the event an ORP requires conversion from cash into another type of reward (e.g., airline miles, points, etc.), the conversion is performed within the OPS based on each financial institution's specific conversion rate(s) for the account associated with the RQP. According to one embodiment, several transactions or a series of transactions must be completed by a consumer in order to qualify as an RQP (e.g., if a TMO dictates three purchases at a particular advertiser must be made in a given time period). Or, in some embodiments, the reward is paid out over an extended time period (e.g., several months) if a consumer continues to make a particular type of purchase or stay enrolled in a particular club or program (e.g., a movie rental membership). In one embodiment, the consumer 103 is notified of the ORP via an icon 119, message, or some other indicator evidencing that a TMO has been successfully redeemed (see FIG. 21 and its associated discussions for further details).

According to one aspect of the TMS 215, financial institutions 205 are reimbursed directly by advertisers via the TMS for the value of all rewards paid to consumers 103. For example, advertiser may have pre-funded accounts within the TMS that are used to reimburse financial institutions for ORPs 225. Or, in some embodiments, the TMS includes a general fund that is used to pay financial institutions, which is in turn compensated by advertisers 213 after the payments to consumers have been made. Additionally, in one embodiment, advertisers pay the operator or operating entity of the TMS for the ability to create and deliver TMCs and subsequent TMOs to consumers (i.e., not just for reimbursement of reward value, but for privilege to use TMS functionality).

As will be understood and appreciated, advertiser creation of campaigns, segments, and TMOs, consumer redemption of those TMOs, transmission of data between the OMS 211, each OPS 207, and each financial institution 205, and other processes of embodiments of the TMS 215 shown and described in conjunction with FIG. 2, occur on a continual and ongoing basis. Further, over time, TMO redemptions and/or impressions are tracked and recorded by each OPS 207, and this data is transmitted to the OMS 211 for reporting to advertisers 213. In this way, advertisers are able to determine the relative effectiveness of their campaigns, manage their return on investments (ROI), and adjust future campaigns and advertisements based on performance of previous campaigns and TMOs.

Additionally, in one embodiment, a system operator or manager has access to all TMS 215 components, and controls and manages overall TMS operations. The system manager accesses the system via a management portal 2915 (see FIG. 23) to perform maintenance on the system, update or make changes to the system, and complete other management tasks.

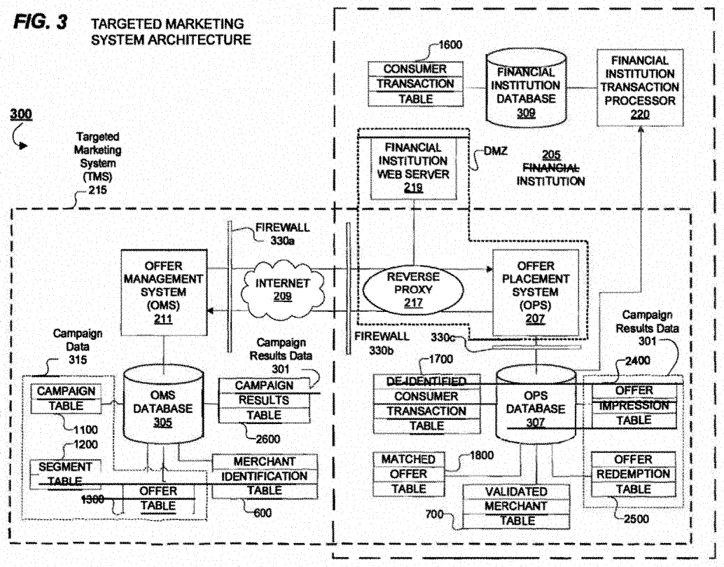

Referring now to FIG. 3, the system architecture 300 for one embodiment of the disclosed TMS 215 is shown. As shown, the architecture 300 includes the OMS 211, at least one OPS 207, databases 305, 307, a plurality of firewalls 330, at least one reverse proxy 217 and the Internet 209. Additionally, the overall system architecture 300 includes connections to one or more financial institutions 205 (including the institution's internal transaction processor(s) 220 and web server(s) 219) and each institution's associated database(s) 309. As will be understood, although only one OPS 207 and one financial institution 205 are shown in the embodiment of FIG. 3, other embodiments include a plurality of OPS's 207 and a plurality of financial institutions 205. Further, as will be appreciated, although only one database is shown each for the OMS, OPS, and the financial institution, embodiments of the present TMS 215 utilize many databases to store system information as needed. In one embodiment, more than one OMS 211 is utilized to perform the campaign creation and management functions of the system. Aspects of the internal hardware components associated with each OMS and OPS are shown and discussed in conjunction with FIGS. 23-24.

According to a preferred embodiment, the OMS 211, OPS 207, and financial institution 205, and their respective components, communicate with each other via a conventional service-oriented architecture (SOA). Generally, a service-oriented architecture is an information technology infrastructure that allows different applications to exchange data with one another. Typically, a SOA separates functions into distinct units or services, which are made accessible over a network (such as the Internet), such that users of the system can combine and reuse them as desired. As will be understood, the communication protocol between the system components shown in FIG. 3 may vary depending upon each financial institution's preferred communication technique, and other similar file transfer mechanisms may be used according to embodiments of the present system.

In the embodiment shown in FIG. 3, the internal components (i.e., processor(s), memory(ies), etc.) of the OMS and OPS are represented by blocks 211 and 207, respectively (see FIGS. 23-24 for more detailed representations). Also included as part of the OMS and OPS are OMS database 305 and OPS database 307, respectively. The OMS database 305 stores data and other information used in the generation of TMCs, analysis of campaign performance, and other similar OMS processes. In one embodiment, the OMS database 305 includes a campaign table 1100, segment table 1200, and offer table 1300 (described in greater detail below) for storing campaign- and advertising-related data (collectively referred to as “campaign data” 315). Preferably, the OMS database also includes a local instance of campaign results data 301 (discussed below), such as that shown in a campaign results table 2600. In one embodiment, the OMS database also includes a merchant identification table 600 for storing data and information used in the cleansing and categorization of merchant names or a Kafka Streaming Global Ktable (14116) as described below.

The OPS database 307 stores data and other information used in matching TMOs to transactions or OTEs (OTEs), displaying such TMOs to consumers, recording redemptions of TMOs, and other similar OPS processes. In one embodiment, the OPS database 307 includes a de-identified consumer transaction table 1700, matched offer table 1800, and campaign results data 301 (represented by the offer impression table 2400 and offer redemption table 2500 (described in greater detail below)) for storing data relating to matched transactions and TMOs, redeemed TMO, etc. According to one embodiment, the OPS database also includes a validated merchant table 700 which effectively serves as a repository for data required to match “raw” merchant names originating from a payment mechanism processor (e.g., credit card reader) to validated (i.e., “normalized”) merchant names suitable for TMOs and redemptions (discussed in greater detail below). Alternatively, and as described below, the process for tracking known merchants in a Kafka Streaming Global Ktable (14116) may be utilized.

Additionally, within the financial institution 205 is at least one financial institution database 309 for storing consumer transaction information. In one embodiment, the financial institution database 309 includes a master consumer transactions table 1600 for storing all consumer transactions recorded within the financial institution. Additionally, in one embodiment, the financial institution database stores an instance of de-identified consumer transaction table 1700 (not shown) for subsequent transmission to the OPS. As will be understood and appreciated by one of ordinary skill in the art, consumer transactions that have not been de-identified (i.e., those in transactions table 1600) remain within the financial institution database, and are unavailable to components of the TMS. As will be further understood, embodiments of the present TMS 215 are not limited to the specific tables mentioned in association with the databases 305, 307, 309, as other tables and data necessary for successful operation of the TMS as will occur to one of ordinary skill in the art are included as well.

As shown in FIG. 3, communications between the OMS 211 and OPS 207 pass through one or more firewalls 330, as well as reverse proxy 217. Generally, each firewall is an integrated collection of security measures designed to prevent unauthorized electronic access to its associated, networked computer system. Depending on the particular financial institution 205, each firewall is a dedicated appliance or software that inspects network traffic passing through it and denies or permits access to network components based on a set of predefined rules. Often, based on heightened security measures typically associated with financial institutions 205, each institution has multiple firewalls, and various distributed components within the institution are located behind varying levels of security (discussed below). In one embodiment, the OMS 211 also includes a firewall 330 a to inspect data and information passed to and from it over the Internet 209. As will be understood, each firewall is configured according to financial institution or system administrator protocols.

According to the embodiment shown, both the financial institution 205 and the OPS 207 utilize distributed architectures with disparate components residing behind varying firewalls 330 b-c (i.e., security levels) for performing functions that require varying levels of security. As shown, an initial firewall 330 b separates the Internet 209 (and, thus, external components, such as the OMS 211) from the financial institution web server 219, the OPS application components 207, and the reverse proxy 217. The area including these components is generally referred to as a DMZ (also referred to as a “demarcation zone” or “perimeter network”), which is defined elsewhere herein. Some embodiments of the present system utilize a DMZ in addition to or in lieu of a reverse proxy to provide additional or alternate security measures. The financial institution web server 219 and OPS sever 207 that reside in the DMZ generally perform the functions of serving web page content to consumers 103, injecting TMOs into the served web pages, and other similar functions. Behind a second firewall 330 c with enhanced security measures reside the financial institution transaction processor 220, financial institution database 309, and OPS database 307. Generally, these components are included behind an additional security layer because they store sensitive consumer information and conduct secure processes, such as matching offers to consumer transaction data, etc. As will be understood, the architecture shown in FIG. 3 is exemplary only, and various financial institutions 205 employ varying architectures and security measures depending on the institution's preferences.

According to a preferred embodiment, in addition to one or more firewalls, a reverse proxy 217 is utilized to provide an extra layer of security to each financial institution's local area network LAN. In one embodiment, the reverse proxy 217 comprises computers and/or processors acting as proxy servers to intercept and inspect all inbound and outbound communications between components on either side of the reverse proxy (in this case, the OPS 207 (in conjunction with the financial institution 205) and the OMS 211). In the embodiment shown, the OPS 207 operates behind both the reverse proxy and the financial institution firewall(s), such that the financial institution and the OPS have a direct communication link (ad described above). In this manner, any information or data passing into or out of the OPS (specifically, from the OMS) is subject to the same layers of protection and security as required by the financial institution. Because of these security components present between the OPS 207 and the OMS 211 (and Internet 209, etc.), embodiments of the TMS 215 are able to operate in compliance with financial institution regulatory guidelines.

### Offer Management System (“OMS”)

As described previously, embodiments of the OMS 211 enable the creation of TMCs, TCSs, and TMOs, cleansing, categorization, and validation of unidentified merchant names, reporting of marketing data and campaign results to advertisers, transmission of data to and from one or more OPSs, and other similar processes. Because TMCs are created via the OMS and then transmitted to individual OPS's installed at separate financial institutions, advertisers are able to create TMCs that are presented across a plurality of financial institutions. Further, because each OPS matches the TMCs to consumer transactions within each financial institution, advertisers are able to market and advertise to consumers based on actual consumer purchase behavior without compromising the privacy or security of the consumer's transaction data. Details and specific functionality associated with the OMS and its processes will now be further described.

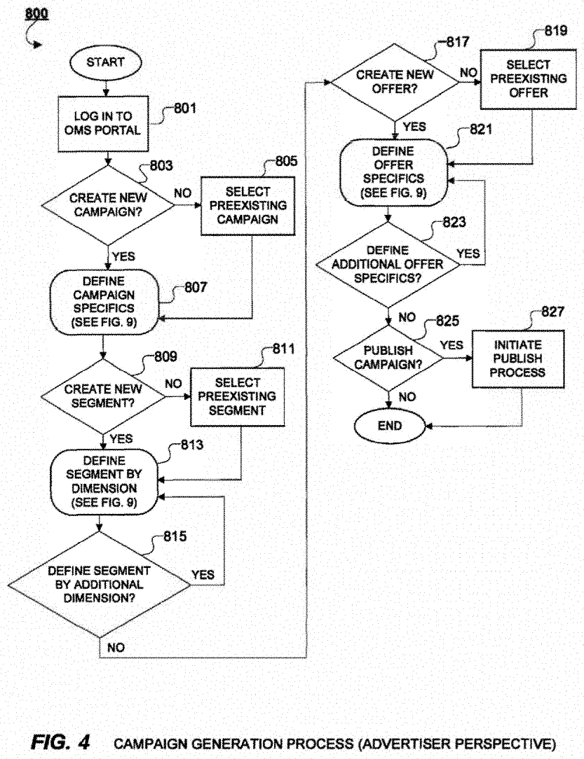

Referring now to FIG. 4, a flowchart is shown illustrating a campaign generation process 800 from the perspective of an advertiser 213 according to an embodiment of the present TMS 215. Such steps are generally computer-implemented, and tied to the operations of a particular machine (OMS 211), but are herein described from the perspective of the advertiser to enable a person skilled in the art of computer programming to construct a suitable computer-implemented user interface. Generally, a campaign comprises one or more TMOs which can be delivered to one or more TCSs. In one embodiment, however, rather than creating an overarching campaign, an advertiser simply creates a singular TMO for delivery to consumers (discussed in greater detail below). Additionally, the process 800 shown in FIG. 4 merely represents one path to creating and/or editing campaigns, segments, and TMOs, and other paths are possible within embodiments of the present system (e.g., defining TMO specifics before or simultaneously with campaign specifics).

As shown in FIG. 4, at step 801, an advertiser 213 logs into the OMS advertiser portal 900 to begin creation of a campaign. As will be understood and appreciated, the person that physically creates the campaign may be an employee of the advertiser (e.g., a member of the marketing team), or a member of an advertisement agency, or some other third party with authorization to create campaigns on behalf of the advertiser. At step 803, the advertiser 213 decides whether he or she is creating a new campaign, or accessing and editing a preexisting (prestored) campaign.

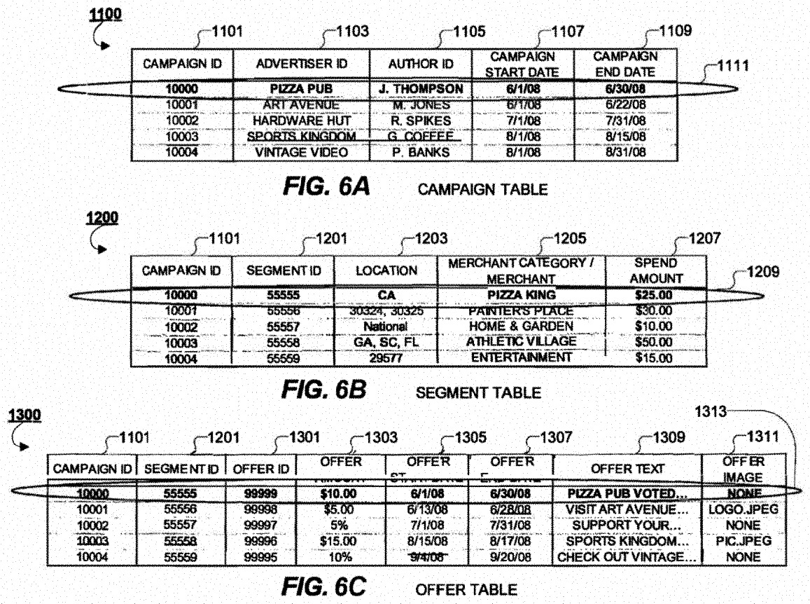

If it is a new campaign, the advertiser defines the campaign specifics (e.g., the name of the campaign, the start and end date of the campaign, etc.) (step 807). If, however, the advertiser is accessing a preexisting (prestored) campaign, then the advertiser selects the particular campaign from a list of the advertiser's stored campaigns via the OMS advertiser portal 900 (step 805). Once selected, the advertiser 213 either confirms the preexisting campaign specifics, or edits the specifics and saves (stores) the changes to the campaign (step 807). Exemplary campaign data is illustrated in table 1100 shown in FIG. 6A.

After a campaign has been created or accessed, the advertiser 213 decides whether he or she wishes to create a new consumer segment, or access a preexisting (prestored) segment associated with the campaign (step 809). Generally, a segment defines a particular group of consumers 103 that will receive TMOs based on the transactions completed by the consumers. Regardless of whether an advertiser 213 creates a new segment, or accesses a preexisting segment from a list of stored segments (step 811), the advertiser defines the segment by a dimension (again, via the OMS advertiser portal 900) (step 813). If it is a preexisting segment, the advertiser may simply confirm the dimension or dimensions associated with the segment. The advertiser may also be given the option to select a segment of consumers likely to belong to a segment based on an algorithm.

As defined previously herein, a “dimension” refers to a delineating category that serves to narrow the population of consumers that may receive a TMO associated with the segment based on criteria associated with specific consumer transactions. Examples of dimensions include the location of the transaction (e.g., zip code(s), city(ies), etc.), the merchant (e.g., Pizza King) or merchant type (e.g., restaurants) with which the transaction was completed, the amount spent, the specific category of items purchased, the payment mechanism associated with the transaction, etc. According to one embodiment, segments (and their associated dimensions) are used to identify and target consumers based not on specific consumer transactions, but on patterns and trends associated with transactions over time (e.g., consumers with high volumes of transactions at health food stores). After the advertiser has defined the segment by at least one dimension, the advertiser is queried as to whether he or she wishes to further define the segment (step 815). If so, steps 813 and 815 are repeated until the segment has been completely defined to the advertiser's satisfaction. If not, the segment is saved (stored), and the advertiser 213 moves forward in the campaign generation process 800. Exemplary segment data is illustrated in table 1200 shown in FIG. 6B.

Still referring to FIG. 4, once at least one segment has been defined or accessed by an advertiser 213, the advertiser either creates a new TMO associated with the segment, or accesses a preexisting (prestored) TMO from a list of stored TMOs (step 817) and assigns it to a respective segment. Typically, a TMO 113 defines an offer for a reward if the consumer 103 completes some subsequent, RQP 117 or series of purchases with the advertiser 213. For example, a TMO may dictate that the consumer will receive $10 off any purchase over $25 made at an advertiser location in the month of June. Often, the TMO may include an advertiser logo or advertising statement, such as “Pizza Pub voted country's best breadsticks!”. In one embodiment, however, rather than a TMO in which consumers are offered a reward for completing a RQP 117, the TMO is purely an advertisement for the advertiser 213 (i.e., the “offer” does not necessarily have to include an associated consumer reward). For example, the TMO may simply comprise the statement: “Pizza Pub voted country's best breadsticks!”, with no corresponding reward offer. As will be understood and appreciated, a plurality of offer specifics (i.e., offer defining information) may be defined by advertisers 213 according to embodiments of the present TMS 215.

Regardless of the offer specifics, these specifics are defined at step 821. If a preexisting TMO was selected (step 819), the advertiser 213 either confirms or edits preexisting specifics, or defines new specifics. After at least one TMO specific has been defined, the advertiser is queried as to whether he or she wishes to further define the TMO 113 (step 823). If so, steps 821 and 823 are repeated until the TMO has been completely defined to the advertiser's satisfaction. If not, the TMO is saved (stored), and the advertiser moves forward in the campaign creation process 800. Exemplary offer data is illustrated in table 1300 shown in FIG. 6C.

At step 825, the advertiser 213 decides whether he or she wishes to “publish” the campaign. If not, the campaign creation process 800 is ended, and the generated campaign is stored for subsequent use. If, however, the advertiser does choose to publish the campaign, then the publish process is initiated 827. Generally, the publication process is initiated once the advertiser is completely satisfied with the campaign and its associated TMO(s), and is ready to deliver the TMOs to consumers 103. In one embodiment, the publish process comprises transmitting the finalized campaign, segment, and offer data to each OPS 207, wherein the data is analyzed and verified by each financial institution 205 and/or a system operator according to each institution's protocols. Essentially, the TMOs are screened to ensure that they comply with the financial institution's specifications (e.g., the formatting is compliant, they do not contain explicit or offending material, etc.), as well as advertising regulations and practices. Once the financial institution is satisfied with the content and format of the campaign, the associated TMOs are matched to qualifying transactions and delivered to consumers (described in greater detail below). According to one aspect, an advertiser 213 may elect to create and store several TMOs associated with a campaign, and then publish the campaign (and its associated TMOs) all at once. In another aspect, TMOs are published individually.

Another aspect of embodiments of the campaign generation process 800 is the “dynamic resegmentation” process (not shown). As used herein, “dynamic resegmentation” refers to the process of automatically delivering follow-up TMOs to consumers that redeem original or initial TMOs. In one embodiment, during the campaign generation process 800, after offers have been defined, advertisers have the option to define a follow-up offer that is automatically presented to a consumer that redeems an initial TMO. The typical goal, from the advertiser's perspective, is to entice the consumer to purchase the advertiser's goods and/or services more than once in the hopes of obtaining the consumer as a repeat and loyal customer.

As mentioned previously, in one embodiment, campaigns, segments, and TMOss are created within the OMS 211 via an OMS advertiser portal 900. Through this portal, advertisers 213 perform the functions of campaign, segment, and offer creation, campaign management, campaign reporting and analysis, billing, and other similar OMS processes.

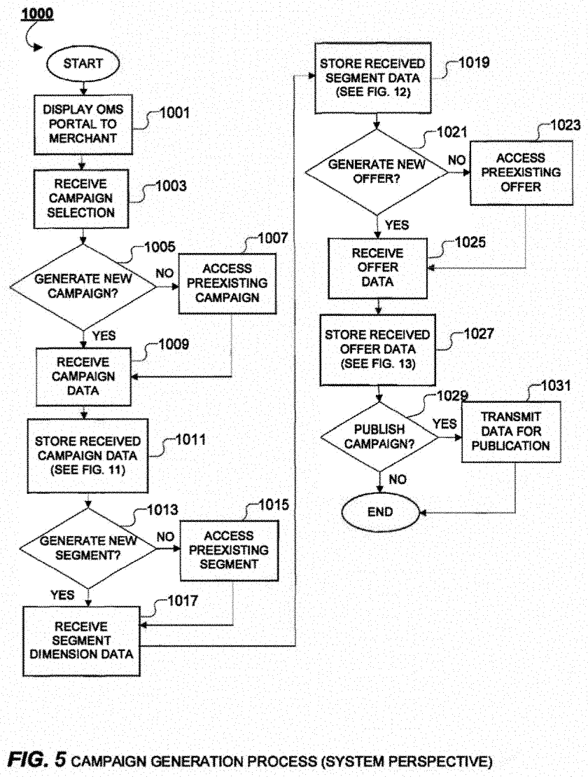

Referring now to FIG. 5, a flowchart is shown illustrating one embodiment of a computer-implemented campaign generation process 1000 from the perspective of the operational steps carried out by the TMS 215. The process 1000 illustrated in FIG. 5 coincides closely with the campaign generation process 800 shown in FIG. 4, except that FIG. 4 tracks the campaign generation process from the advertiser perspective, whereas FIG. 5 describes computer-implemented steps of the campaign generation process from the system perspective (in response to advertiser-entered data). At step 1001, the system 215 displays a GUI associated with the OMS advertiser portal 900 to an advertiser 213. Generally, the advertiser either selects a preexisting campaign or chooses to generate a new campaign. Accordingly, the system receives the advertiser's selection (step 1003). If a new campaign is selected (step 1005), the system awaits and subsequently receives campaign data entered by the advertiser (step 1009). If a preexisting campaign is selected (i.e., a campaign previously created by the advertiser), the system accesses the preexisting campaign (step 1007), and then receives advertiser-entered campaign data (if any). Once all campaign-related data has been received, the data is stored in the OMS database 305 (step 1011) (see FIG. 6A for exemplary campaign table that reflects and represents stores campaign-related data).

After a campaign has been selected and stored, an associated segment is typically created or selected for editing. If a new segment is selected for creation (step 1013), the system awaits and subsequently receives segment data entered by the advertiser (step 1017). If a preexisting segment is selected (i.e., a segment previously created by the advertiser), the system accesses the preexisting segment (step 1015), and then receives advertiser-entered segment data (if any). Once all segment data has been received, the data is stored in the OMS database 305 (step 1019) (see FIG. 6B for exemplary segment data table).

After a segment has been selected and stored, an associated offer is typically created or selected for editing. If a new offer is selected for creation (step 1021), the system awaits and subsequently receives offer data entered by the advertiser (step 1025). If a preexisting offer is selected (i.e., an offer previously created by the advertiser), the system accesses the preexisting offer (step 1023), and then receives advertiser-entered offer data (if any). Once all offer data has been received, the data is stored in the OMS database 305 (step 1027) (see FIG. 6C for exemplary offer data table). At step 1029, the system queries the advertiser 213 as to whether the advertiser would like to publish the campaign. If the advertiser does not wish to publish the campaign, then the campaign generation process 1000 is ended. If, however, the advertiser does wish to publish the campaign, then the campaign data is transmitted to each OPS 207 and the publication process is initiated (discussed previously).

FIGS. 6A, 6B, and 6C are exemplary data tables or structures illustrating representative data that was received and stored during the campaign generation process 1000. As mentioned previously, the collection of data contained in these tables (i.e., tables 1100, 1200, 1300) is generally referred to herein as “campaign data” 315. As will be understood, tables 1100, 1200, 1300 are presented for illustrative purposes only, and embodiments of the present system 215 are not limited to use of the specific data tables shown. In one embodiment, the three disparate tables are merged into one large data file within the OMS database 305. In another embodiment, a relational data table or index (not shown) stores and associates each campaign ID with its corresponding segment ID(s) and offer ID(s) such that offers, segments, and campaigns may be queried and tracked in relation to one another.

FIG. 6A is an exemplary campaign table 1100 illustrating advertiser-entered, campaign-related data received during campaign generation, as reflected by a plurality of entries in the table, each entry having a plurality of predetermined data fields. As shown, the table 1100 includes five data categories or fields: campaign identifier 1101, advertiser identifier 1103, author identifier 1105, campaign start date 1107, and campaign end date 1109. As will be understood, however, the data categories or files are not limited to the fields shown, and other embodiments include additional fields, including those mentioned previously herein, as well as those not mentioned that will occur to one of ordinary skill in the art. As will also be understood, although only five data entries are shown in the table (i.e., entries corresponding to exemplary and illustrative campaign IDs 10000-10004), actual data tables constructed in accordance with embodiments of the present system may include a virtually unlimited number of entries corresponding to a plurality of campaigns created by advertisers 213 utilizing aspects of the present system.

As shown, the campaign ID field 1101 indicates a unique campaign identifier associated with each campaign. Each campaign identifier is generated by an embodiment of the TMS 215 and associated with a respective campaign as each campaign is generated by an advertiser 213. Although the campaign IDs are illustrated as 5-digit numbers, it will be appreciated that these unique identifiers may comprise many formats, including number strings of longer length, hexadecimal identifiers, binary identifiers, and the like. The advertiser ID field 1103 indicates the particular advertiser associated with each campaign. The author ID field 1105 indicates the individual system user that actually created each campaign. Further, the campaign start and end date fields 1107, 1109 indicate the beginning and end dates for each campaign. As mentioned previously and according to various embodiments, these dates may or may not correspond to TMO start and end dates, may or may not coincide with financial institution account billing cycles, etc. Representative campaign 1111 corresponds to the Pizza Pub/Pizza King example referenced in other parts of this disclosure.

FIG. 6B is an exemplary segment table 1200 illustrating advertiser-entered, segment-related data received during campaign generation, as reflected by a plurality of entries in the table, each entry having a plurality of predetermined data fields. As shown, the table 1200 includes five data categories or fields: campaign identifier 1101, segment identifier 1201, location 1203, merchant category/merchant 1205, and spend amount 1207. In particular, it will be appreciated that the campaign ID 1101 provides a link or connection of a particular segment to a particular campaign, so that a particular segment represented by an entry in a segment table is associated with a particular campaign. For example, in the entry 1209, the segment ID 55555 is a segment associated with campaign ID 10000.

It should be understood that the data categories or files are not limited to the fields shown in FIG. 6B, and other embodiments include additional fields, including those mentioned previously herein, as well as those not mentioned that will occur to one of ordinary skill in the art. As will also be understood, although only five data entries are shown in the table (i.e., entries corresponding to segment IDs 55555-55559), actual data tables constructed in accordance with embodiments of the present system may include a virtually unlimited number of entries corresponding to a plurality of segments created by advertisers 213 utilizing aspects of the present system.

As shown, the segment ID field 1201 indicates a unique segment identifier associated with each segment. Each segment identifier is generated by an embodiment of the TMS 215 and associated with a respective segment as each segment is generated by an advertiser 213. Just as with the campaign identifiers, the segment identifiers comprise various formats within various embodiments of the present TMS 215, and are not limited by the 5-digit number format shown. Additionally, as each segment identifier is generated, it is associated with a respective campaign identifier (shown in campaign ID field 1101 in the segment table 1200) within the OMS database 305 to create a link between the segment and its corresponding campaign. The link between the segments and campaigns enables information in both tables to be accessed when either a specific segment or campaign is queried or accessed. The location field 1203 indicates, in one embodiment, one or more locations in which consumer transactions that are part of each respective segment may occur. In another embodiment, the location field 1203 indicates the location of consumer billing addresses. In further embodiments, the location field 1203 represents another location as will occur to one of ordinary skill in the art.

Still referring to FIG. 6B, merchant category/merchant field 1205 indicates a particular merchant 101 (FIG. 1), merchants, or category of merchant with which consumer transactions that are part of the respective segment are carried out. Generally, the spend amount field 1207 indicates a minimum amount that each consumer must have spent, either via a single transaction or cumulatively across many transactions over the specified campaign time period, in order to qualify as part of a given segment. As shown, representative segment 1209 corresponds to the Pizza Pub/Pizza King example referenced in other parts of this disclosure.

FIG. 6C is an exemplary offer table 1300 illustrating advertiser-entered, offer-related data received during campaign generation, as reflected by a plurality of entries in the table, each entry having a plurality of predetermined data fields. As shown, the table 1300 includes eight data categories or fields: campaign identifier 1101, segment identifier 1201, offer identifier 1301, offer amount 1303, offer start date 1305, offer end date 1307, offer text 1309, and offer image 1311. As will be understood, however, the data categories or fields are not limited to the fields shown, and other embodiments include additional fields, including those mentioned previously herein, as well as those not mentioned that will occur to one of ordinary skill in the art. As will also be understood, although only five data entries are shown in the table (i.e., entries corresponding to offer IDs 99999-99995), actual data tables constructed in accordance with embodiments of the present system may include a virtually unlimited number of entries corresponding to a plurality of offers created by advertisers 213 utilizing aspects of the present system.

As shown, the offer ID field 1301 indicates a unique offer identifier associated with each offer. Each offer identifier is generated by an embodiment of the TMS 215 and associated with a respective offer as each offer is generated by an advertiser 213. Just as with the campaign and segment identifiers, the offer identifiers comprise various formats within various embodiments of the present TMS 215, and are not limited by the 5-digit number format shown. Additionally, as each offer identifier is generated, it is associated with a respective segment identifier and campaign identifier (shown in campaign ID field 1101 and segment ID field 1201 in the offer table 1300) within the OMS database 305 to create a link between the offer and its corresponding segment and campaign. The link between the offers, segments, and campaigns enables information in any of tables 1100, 1200, or 1300 to be accessed when a specific offer, segment, or campaign is queried or accessed.

Generally, the offer amount field 1303 indicates a reward amount or value a consumer 103 will receive if he or she completes a RQP 117 associated with the TMO. The offer amount is generally entered by an advertiser within the OMS advertiser portal 900 as either a dollar amount or a percentage of a subsequent RQP, although other advertiser-entered offer amounts are possible within embodiments of the present system as will occur to one of ordinary skill in the art. In one embodiment, the offer amount is converted to an equivalent value of financial institution rewards currency (e.g., points, miles, etc.) before the TMO is displayed and/or paid to the consumer (described in greater detail below in conjunction with FIG. 17). Typically, if the offer amount is converted to rewards currency, it is so converted by each OPS 207 based on predetermined conversion ratios set by each financial institution 205. In one embodiment, each consumer account associated with a particular rewards currency at a financial institution is grouped into a portfolio for that particular rewards currency to enable efficient conversion of offer amounts. In an alternate embodiment, the offer amount is predefined by an advertiser in a rewards currency or currencies, and thus TMO are only displayed to consumers that have accounts that utilize the specific defined rewards currency(ies). As mentioned, according to the preferred embodiment, the offer amount is automatically issued/paid to each consumer's account by the respective OPS 207 and financial institution 205 once (if) a RQP has occurred.

Although not shown, in one embodiment of the present system 215, an offer-qualifying amount is defined as an item of offer defining information, indicating a minimum amount a consumer 103 must spend via the RQP 117 in order to receive the reward (i.e., offer amount). For example, an advertiser may dictate that, after a consumer has received a TMO, the consumer must spend more than $25 in a follow-up purchase or purchases in order for the purchase(s) to qualify as an RQP. In the offer start and end date fields 1305, 1307, beginning and end dates are indicated for TMO presentment to consumers. According to one embodiment, advertisers 213 may elect to “abandon” an TMO (or entire campaign) prior to the end date if, for example, the consumer response rate to the campaign or TMO was higher than expected. Generally, however, if an TMO or campaign is abandoned, consumers that have already received the abandoned TMO will remain eligible to redeem it according to its stipulated offer specifics.

Still referring to FIG. 6C, the offer text field 1309 indicates a message, advertisement, or text presented to each consumer 103 with each respective TMO. Further, the offer image field 1311 indicates an image or picture uploaded and defined by an advertiser 213 to be included with the TMO. Generally, the image comprises a advertiser logo, but virtually any image may be included. As shown, representative TMO 1313 corresponds to the Pizza Pub/Pizza King example referenced in other parts of this disclosure.

### Offer Placement System (OPS)

As described previously, embodiments of the OPS 207 enable matching of received campaign data from the OMS 211 with de-identified consumer transaction data received from financial institutions 205, injecting or merging TMOs into financial institution portals for review by consumers 103, transmission of unidentified merchant names to the OMS for validation, organizing and transmitting offer redemption data to financial institutions for reimbursements to consumers, transmitting of results (i.e., performance) data to the OMS, and other similar processes as described herein. Generally, at least one OPS 207 is in operative association with each financial institution location, preferably located behind the institution's firewall(s) and reverse proxy 217, thus enabling direct communication with each financial institution while maintaining financial institution-level security with outside components (such as the OMS) (see FIG. 3 and its associated discussion for further details of OPS and financial institution architecture). Details and specific functionality associated with the OPS and its processes will now be further described.

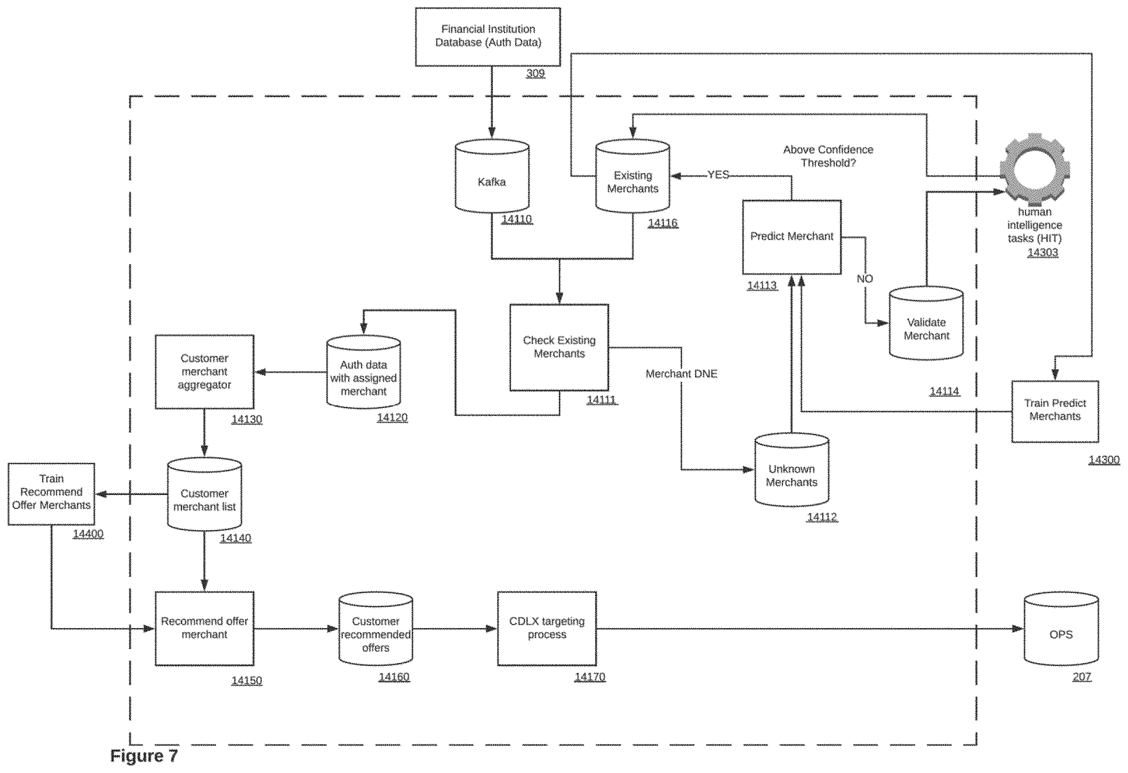

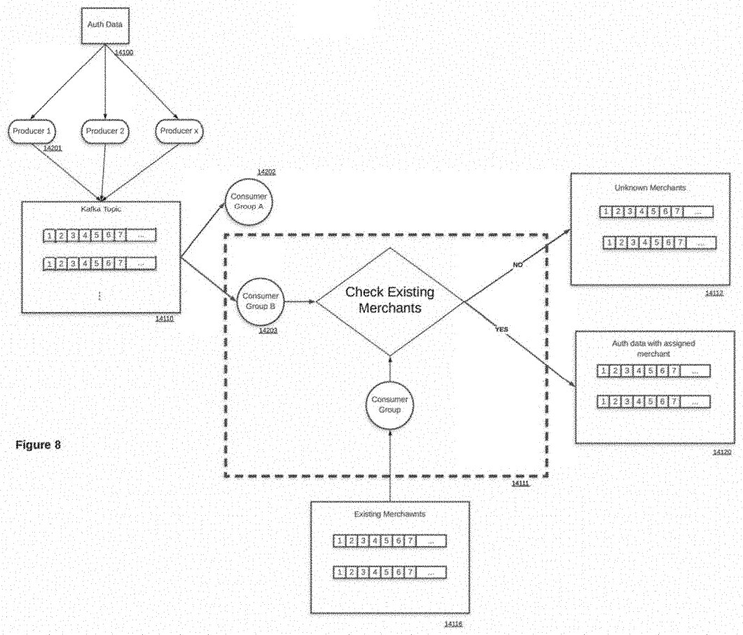

FIG. 7 is a flowchart illustrating the overall computer-implemented processes and functions performed by the OPS 207 according to yet another embodiment of the present TMS 215. In FIG. 7, the OPS 207 is improved by allowing for real-time receipt of data from the financial institution 205. The flowchart of FIG. 7 depicts the flow of the invention is this embodiment, with reference to FIGS. 8 (Kafka stream-processing), 9 and 10 (training), and 11 and 12 (data examples).

According to the embodiment depicted in FIG. 7, authorization data 309 is sent from the financial institution 205 and goes into the Kafka stream 309. The Kafka stream 14110 is depicted in further detail in FIG. 8. Authorization data 14100 may be sent to the ingestion API of the Kafka stream 309 one by one in order. The ingestion API will produce each of the message to the Kafka Topic in the Kafka Cluster via Producers 14201. There can, in one embodiment, be many instances of ingestion API to improve the throughput. Once the message lands in the Kafka Topic, multiple KStream application instances 202, 203 may consume the message from the topic as a Kafka Consumer Group to check existing merchants (14111, 14116).

In one embodiment, the topic messages are read by consumer groups message by message, in the order that the message was received (14204). For each message, the Kstream app checks against a Kafka Streaming Global Ktable (14116). This may comprise a full list of known merchant strings with related merchant info.

If a known merchant is found (14111), then the message will be enriched with the merchant info (from 14116) and produced to the downstream topic (14120) If a known merchant is not found, then the message will be produced to another topic which only stores the authorization messages with unknown merchants (14112), and then a Kstream application will consume from this topic and feed it to the Predict Merchant Model (14113)

Predict merchant 14113 is a predictive classification model that will take an authorization string as input and output a predicted known merchant. The training step (14300) may be divorced from the steaming process, whereby the steaming process assumes a pre-trained classification model exists as an API.

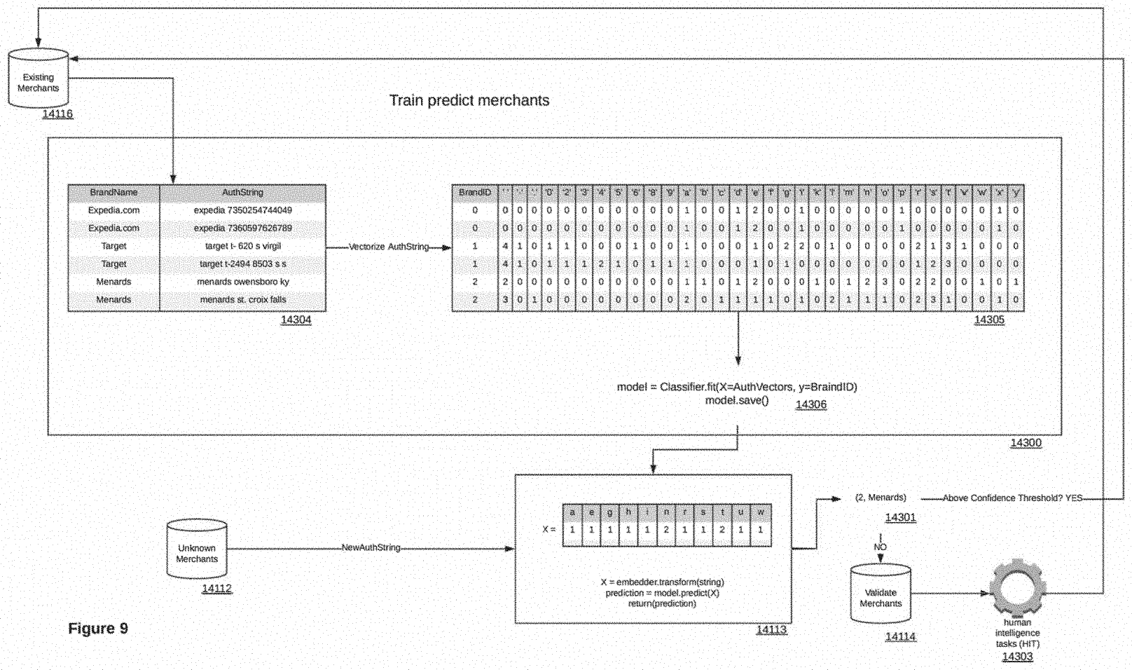

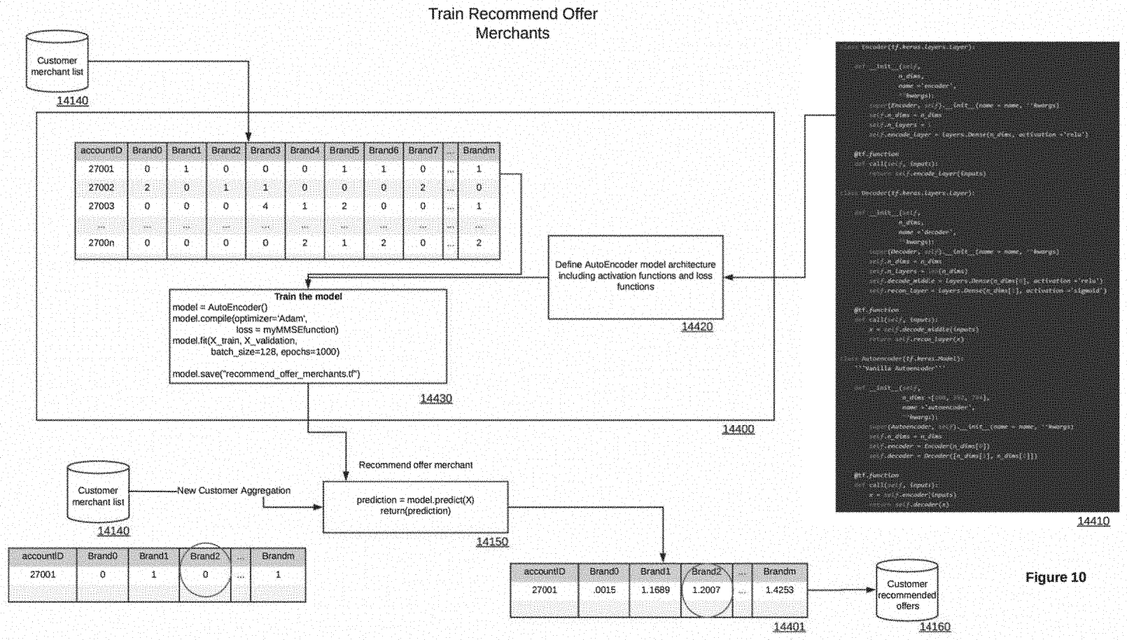

FIG. 9 illustrates the training process to predict merchant (14300), described in further detail below.

Sample known authorization strings and merchant names are obtained from Existing Merchants (14116) so that labelled data is gathered to build a supervised classification model (14113). The sample strings are then split into training and tests sets, and the authorization strings are embedded (14305) so that a mathematical representation of the string can exist to train the model. One embedding embodiment that may be used is count vectorizer.

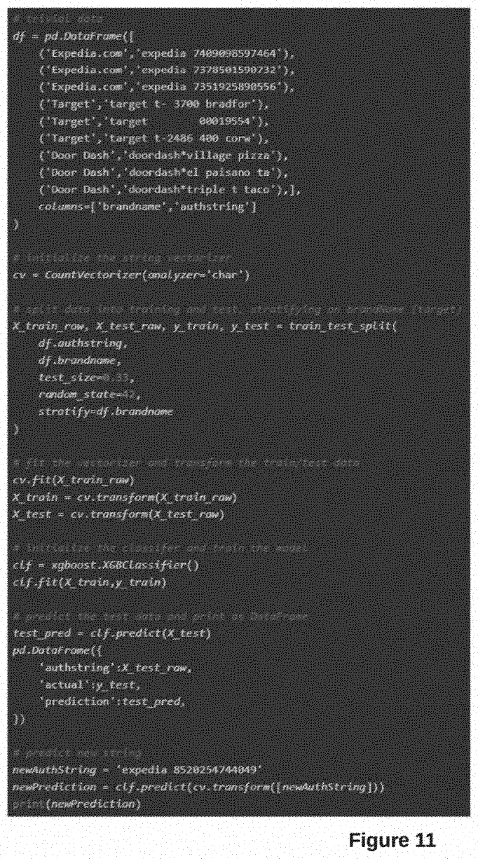

The classification model may be trained using the training dataset, and then the test dataset is used to obtain a measurement of accuracy of the model (14306). The model is deployed as an API that the streaming service is able to access (14113). FIG. 11 is a trivial example of a classification algorithm that could be used to predict a merchant. The streaming service can then embed the string, use the predict method of the model API, and receive merchant name prediction (14301). New authorization strings stream into Kafka (FIG. 8) and in one embodiment are not mapped to an existing merchant.

If the prediction is above a confidence threshold, the authorization string is sent to existing merchants topic with newly mapped merchant (14116). If the prediction is below the confidence interval, the authorization string is moved to validation topic for a process to validate and re-map the string to correct merchant (14302). One embodiment of this can be a human in the loop analyzing low confidence authorization stings and adding them back to the existing merchants database/topic (14303). In another embodiment, this may be automated. For example, fuzzy matching techniques may be used, using cosine similarity to find a better match for the string. A brute force search may be used to compare a low threshold string to every other identified or classified string, to find a better match.

Once these low confidence strings are mapped, they get placed back into “existing merchants” with the correct label, which can go through the training process again and new similar strings should have a higher confidence moving forward (14116).

The authorization string with assigned merchant name is inserted into the earlier mentioned Kafka Stream Global KTable, and the original raw authorization message (14111) will be produced back to the original raw topic to be re-processed (14120)

This data is sent to a customer merchant aggregator (14130) because each individual authorization record exists in the authorization database (14120). The aggregator will utilize these individual records: for example, if an account spent at Burger Joint 5 separate times, and also Coffee Shop 5 separate times, then 10 authorization records would exist for 2 different BrandIDs. The data will will then be reduced by the AccountID key into 1 record and sent to Kafka topic Customer Merchant List (14140). with a sample output such as:

AccountID|BurgerJointID:5, CoffeeShopID:5.

The aggregated data customer merchant Kafka stream (14140) will be fed into Recommend Offer merchant (14150). Recommend Offer Merchant 14150 may be, in one embodiment, a pretrained autoencoder network that will take an customer merchant list stream (14140) as input and output a prediction vector for each input merchant (14401). These predictions are sent to the Customer recommended offers Kafka stream (14160). The training step (14400) may be divorced from the steaming process, in which case the steaming process assumes a pre-trained autoencoder network exists as an API.

An autoencoder is a 2-step process: an encoder and a decoder. The idea of an autoencoder is to take a set of features, for example 10, and compress those features down into a smaller set of features, for example 3. The decoder then takes those 3 features and uncompresses them back into 10 features. This is a form of unsupervised learning, since the model is just learning how to compress and decompress the features and how the features are correlated with each other. In the end, if a consumer shopped at brandA and brandB, this process will compress and uncompress the associated data, and will end up with brandA, brandB, and brandC as the uncompressed output, whereas brandC is now the recommendation for the consumer.

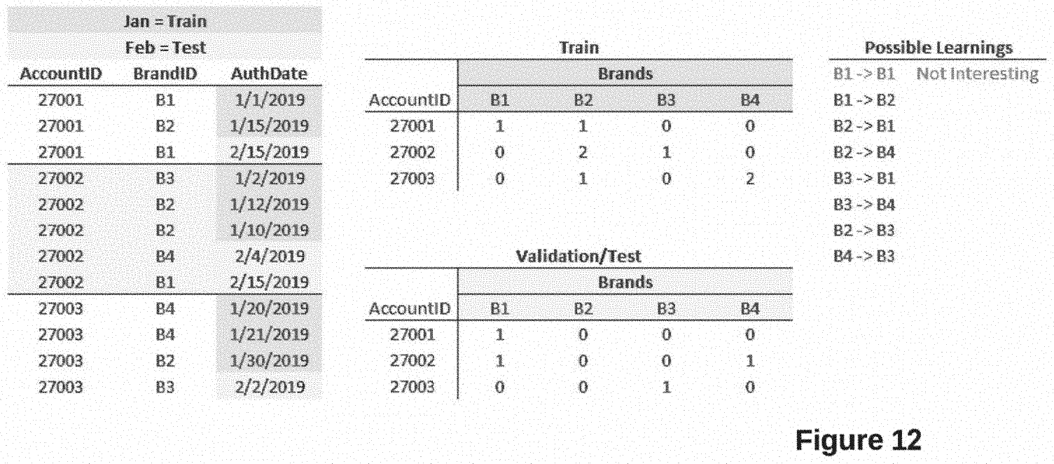

For training the autoencoder (14400), accounts are sampled from customer merchant list (14140) and represent the sparse data as a dense n customers by m merchants vector. The data can be split into training, test, and validation datasets by time (see FIG. 12) to incorporate the temporal nature of spending habits. Next the autoencoder architecture is defined including loss and activation functions (410, 420, where 410 is a high level example of 420 [trivial code]). Finally the model is trained (14430) using train and validation datasets, and a final model accuracy is obtained using the test set. The model may be exposed as an API in Recommend Offer merchants (14150).

Customer Recommended Offers may be fed into the targeting process (14170) which can apply business logic to determine if a TMO should be provided to an account (i.e. advertising budget, bank restrictions, etc.) and places newly eligible TMOs for a customer on their banking platform (207).

Referring again to FIG. 8, to create a prediction API application to produce a message to a Kafka topic, in one embodiment the application may instantiate an instance of a Kafka producer by using the Apache Kafka java client library with configuration information to produce to a Kafka topic.

For example, to consume unknown merchants (14112) the predict merchant streaming app (14113) will pull from the unknown merchants topic in the Kafka cluster, using the Apache Kafka java client library. To produce the prediction message (14301) to the existing merchants topic (14116), the streaming predict merchants app will push to the existing merchants topic in the Kafka cluster.

The customer merchant aggregator streaming application (14130) may consume from the auth data with assigned merchant topic (14120). The application will aggregate the long format data, grouping by customer key to produce messages to the customer merchant list topic (14140).

In general, streaming applications are consumers and producers of Kafka topics. The applications will pull the messages from the topic, process the message, and push the new messages to the next topic. In the exemplary figures, applications are denoted with squares, and Kafka topics are denoted with a database symbol.

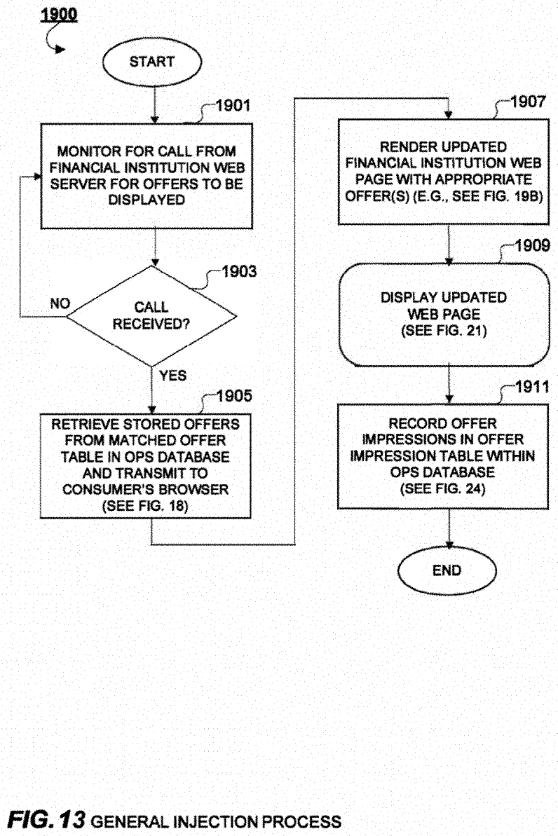

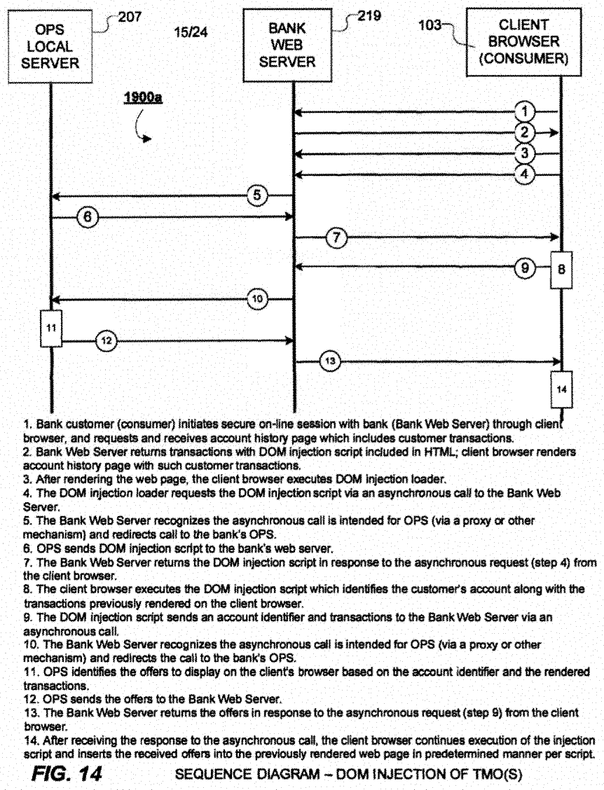

Targeted Marketing Offer Injection or Merging into Display of Financial Institution Portal FIGS. 13 and 14 illustrate a computer-implemented process for injecting or merging a selected TMO into the display of an financial institution portal provided by a financial institution, in accordance with aspects of the claimed invention(s). As will by now be understood, once the disclosed TMS 215, via the operations of the OMS 211 and OPS 207 as described herein, has carried out prior processes of processing transaction data to provide a basis for identifying market segments, creating a campaign from such processed transaction data by determining appropriate market segments for receiving TMOs, establishing the terms and conditions for a TMO within such segments, and determining that predetermined TMO display conditions have been satisfied by a consumer's action (e.g., a predetermined transaction or other OTE), the TMS 215 displays information corresponding to the TMO to the consumer via the financial institution portal. In one particular aspect, the TMO information is displayed in close juxtaposition, proximity, or other discernible association with the consumer's prior transaction information as the consumer views the same via their financial institution portal.

FIG. 13 is a flowchart illustrating an embodiment of an injection process 1900 for injecting or merging matched offers into an online financial institution portal in association with consumer transaction displays when a consumer logs in and views his or her financial institution portal. FIG. 13 is a more generalized offer injection process 1900, whereas FIG. 14 (discussed in greater detail below) illustrates a specific implementation of one embodiment of a document object model (DOM) injection process 1900 a for injecting offers into consumer financial institution portals.

In general, embodiments of the claimed invention(s) utilize a form of “cross-site scripting” in order to effect the merger or injection of TMOs into the financial institution portal, or other similar technique which does not require significant computing resources, programming, or modification of the financial institution web server code that generates the portal on behalf of a consumer. As known to those skilled in the art, many modem web browser programs that run on consumers' computers or other web-accessing devices (such as smart phones) include embedded program code execution engines. Such modem browsers include well known programs such as Microsoft's Internet Explorer, Mozilla Firefox, Apple Safari, Google Chrome, and others. Embedded program code execution engines include those identified as Javascript, Flash, XML, PHP, CSS (Cascading Style Sheets), ASP, and others.

Generally speaking, such embedded program code is computer-executable program code that is downloaded at run time from a web site and executed within the browser environment at a local (client) computer, instead of code that is executed at a server computer that provides the HTML or similar code commonly associated with a “web page.” Further generally speaking, a cross-site scripting method typically involves the downloading of computer program code from a primary web server that generates the display of a web site (such as HTML that generates the financial institution portal), which embeds a minimal script or call to download and run computer program code from another server (e.g. a script server or another process in the primary web server) that effects the functionality of the TMO injection or merger into the portal display.

According to one aspect of the claimed invention(s), and according to one embodiment, a cross-site scripting method utilizes the Javascript code execution capability of modern web browsers to run a script that merges or injects information corresponding to a TMO into the financial institution portal display of a consumer's account history comprising a plurality of transactions of the viewing consumer. The web page comprising the portal display, typically an account history page comprising a list of the consumer's prior transactions, is dynamically adjusted to incorporate (merge, inject) the TMO information into the display of transactions of the financial institution portal, in an unobtrusive and aesthetically acceptable manner and format. Advantageously, the financial institution portal is independent of and systemically uncoupled from the TMO injection, such that (a) the TMO information is seamlessly and unobtrusively presented to the consumer in accordance with predetermined advertisement placement information (such as display the TMO adjacent to a selected transaction, display the TMO in a predetermined position on the portal display screen, etc.) and (b) any issues with operation or security of the injection process will not affect the operation of the financial institution portal, which will continue to operate and serve the consumer's needs whether or not any TMOs are presented.

Although the disclosed embodiments and aspects are described in connection with use of Javascript code embedded into the HTML of the financial institution portal, it should be understood that other techniques for merging or injecting the TMO information into the portal can be employed, such as by certain forms of redirection to another site, use of browser frames, and the like, but other techniques may present technical or business issues that are more complex than a simple merger or injection operation. For example, the known security policy of “same origin” for a script and a document or code that contains a script is satisfied in disclosed aspects of the claimed inventions by use of a proxy at the financial institution web server that redirects a call for script to the OPS residing within the financial institution's firewall within its DMZ.

Prior to discussing the specific methodology of TMO merger or injection by use of a scripting technique, a more generalized discussion of the preferred merger or injection process will be provided by reference to FIG. 13.

Starting at step 1901 in FIG. 13, an OPS 207 monitors for a call from its respective financial institution's web server 219 for previously-matched offers. In accordance with one aspect of the disclosed system, each time a consumer 103 logs in to his or her financial institution web portal, a call is automatically transmitted from the financial institution web server to the OPS to retrieve the matched offers (if any) associated with the particular consumer's account transactions (based on the consumer's GUID). In accordance with one disclosed aspect of the claimed invention(s), for this call to occur, a relatively minimal amount of JavaScript code (or some other similar programming language) is inserted into the financial institution's portal code at a previous time when an OPS is initially connected to the financial institution 205. When a consumer's browser loads the financial institution portal display (and especially an account history page comprising a list of prior transactions of the consumer), this JavaScript code (i.e., “script call code”) calls a larger segment of code contained within the OPS that performs the functions of retrieving matched offers and injecting those TMOs into the financial institution's web portal display to the consumer.

The preferred process of utilizing a small amount of software code inserted into a previously-existing code base to call a disparate and more extensive algorithm enables connection of the TMS (and specifically, the OPS) to the financial institution with minimal initial or on-going effort on the part of the financial institution. Preferably, a JavaScript DOM injection is used to access and execute code stored within the OPS to modify the financial institution's online portal each time a consumer logs in and views his or her account display. Accordingly, there is no server involvement from the financial institution's 205 perspective with the TMO injection, as all processes occur within the OPS 207, except at the point of web display to the consumer. This functionality is made possible based on the system architecture 300 of embodiments of the TMS 215, wherein each OPS is directly connected to each financial institution within the financial institution's security infrastructure.

Further, because minimal intrusion into the financial institution's preexisting software code is required, both the financial institution 205 and any associated OPS 207 are free to update and revise their code bases as needed without changing or updating the interaction between these two systems. Additionally, based on the discrete nature of the system architecture 300, if problems occur with either the TMS or financial institution systems individually, these problems can be confined within each respective component or domain without affecting or infecting the other components. As will be known to those of ordinary skill in the art, while a JavaScript DOM injection is utilized according to one embodiment, other embodiments utilize other scripting, cross-site scripting, or other similar mechanisms for retrieving and rendering updated financial institution web displays with matched offers.

Still referring to FIG. 13, if a call is received from the financial institution 205 (indicating a consumer 103 has logged in to the financial institution portal to view his or her account and transactions, e.g. via an account history page), then the stored, matched offers associated with the particular consumer's transactions are retrieved from the matched offer table 1800 maintained by the OPS in the OPS database 307 (step 1905). If a call is not received, then the OPS 207 again monitors for a call from the financial institution online system (step 1901) via a continuous monitoring loop. In one embodiment, if a call is received, then the OPS searches its matched offer table according to the GUID associated with the received call from the financial institution (step 1905). Once the TMOs (if any) associated with a given consumer's transactions are retrieved, information corresponding to the selected TMO's is transmitted to the consumer's browser, and the injection process updates the previously rendered web page associated with the financial institution portal with such retrieved TMO information, thereby displaying the retrieved TMO(s) to the consumer (steps 1907, 1909) (see FIG. 16). Stated in other words, and according to one aspect of the claimed invention(s), the consumer views his or her account history page initially as originally intended and as originally programmed by the financial institution web portal, and that account history page is updated by the consumer's browser, which receives the TMO information asynchronously to the account history web page display, by locally executing the injection script which dynamically and independently modifies the prior account history display to provide an updated account history display that incorporates the TMO information merged therein.

In one embodiment, the updated consumer financial institution web page is displayed via a hypertext markup language (HTML) web service, or other similar service. As will be understood and appreciated, according to one embodiment, calls to retrieve matched offers may occur with relatively high frequency (possibly hundreds or thousands per minute), and thus the process 1900 shown in FIG. 13 (and particularly steps 1901 and 1903) is repeated on a continual and rapidly-recurring basis.

Each time the updated financial institution web page is rendered and displayed to a consumer 103 (steps 1907, 1909), the OPS 207 records the offer impression for each displayed TMO in the offer impression table 2400 (see FIG. 18 and its associated discussion) (step 1911) in the OPS database 307. As defined previously herein, an “offer impression” represents an instance of a consumer logging in to his or her financial institution portal 2100 and viewing the displayed TMO associated with displayed transactions. It is inferred that when a TMO is injected into the consumer's financial institution portal, the consumer sees the TMO. According to one embodiment, a consumer transaction cannot qualify as a RQP for a particular TMO until the OPS recognizes that at least one offer impression of the TMO has occurred for the consumer. Furthermore, offer impressions assist advertisers 213 in tracking and assessing the performance of their campaigns and associated advertisements, as analytics are determined regarding the number of times a consumer viewed a TMO before redeeming it, how many times, generally, TMOs are viewed per month, etc. The details associated with offer impressions and the offer impression table are discussed below.

In accordance with aspects of the claimed invention(s), a DOM injection process is utilized to effect the dynamic updating of a consumer's display to include TMOs in the display, as described next in connection with FIG. 14. In this embodiment, the script that effects the injection or merger of the TMO information is provided from a server associated with the OPS (identified as OPS local server 207 in FIG. 13, also called a “script server”), as a result of calls provided to it from a bank web server 219.

FIG. 14 is a sequence diagram illustrating one embodiment of the steps associated with injecting matched offers into consumer financial institution portals via a DOM injection process 1900 a. As shown, the embodiment of the DOM injection process generally comprises three system components-a client browser (i.e., consumer 103 accessing a financial institution portal), a bank web server (i.e., financial institution web server) 219, and a local server associated with the OPS 207 (i.e., a server residing behind financial institution firewalls and operatively coupled to OPS database 307).

At step 1 in FIG. 14, the consumer 103 initiates a secure, on-line session with the financial institution 205 via the consumer's web browser for purposes of reviewing his or her transactions, managing his or her accounts, etc. Typically, the consumer will be requesting a display of an account history page comprising a list of prior transactions maintained by the consumer's financial institution. At step 2, the client browser requests, receives from the financial institution web server 219, and renders the consumer's transaction display 2000 (discussed below), including the consumer's recent transactions associated with a specific account. At step 3, after the consumer's transactions display web page has been rendered, the client browser requests and executes a DOM Injection Loader (i.e., a minimal amount of code inserted into bank's web services code, discussed previously, whose primary purpose is to invoke the operation of an embedded code engine associated with the browser, such as Javascript).

At step 4, the DOM Injection Loader then requests a DOM Injection Script (i.e., more extensive executable code or script stored within the OPS 207 that executes offer insertion or injection functionality, discussed previously) via an asynchronous call to the financial institution web server 219. The call for the injection script typically includes an identifier of the consumer and a network return pathname (URL) for returning the script and other information (such as the TMO information) from the OPS to the client machine.

At step 5, the financial institution web server 219 recognizes that the asynchronous call is intended for the OPS (via a reverse proxy 217 or other similar mechanism) as a script server, and redirects the call to the OPS local server.

At steps 6 and 7, upon receipt of the asynchronous call, the OPS 207 acting as a script server transmits a DOM Injection Script back to the bank's web server 219, which then returns the DOM Injection Script to the client browser (in response to the browser's asynchronous request) via the network return pathname. At step 8, the client browser executes the DOM Injection Script for purposes of identifying the particular consumer account being accessed along with the consumer transactions previously rendered to the consumer 103 via the transactions (account history) display.

At step 9, after the consumer's account and transactions information have been identified, the DOM Injection Script transmits this information to the financial institution web server 219 via another asynchronous call, and the web server again redirects the call to the OPS local server (step 10). Stated in other words, the information in the account history display, which either has been or will be displayed to the consumer by the bank web server, is transmitted to the OPS local server so that this information can be used to access the matched offer table 1800 (FIG. 18) and determine if any TMOs are available for provision to the consumer.

At step 11, and still referring to FIG. 14, once the OPS 207 receives the asynchronous call redirected from the bank web server, the OPS identifies and determines which TMOs should be displayed to the consumer 103 via the financial institution portal based on the particular consumer account and the rendered transactions. In order to determine which TMOs to transmit back to the bank's web server (and thence to the consumer's browser) for display to a consumer, the OPS searches the matched offer table 1800 in the OPS database 307 and retrieves TMOs associated with the consumer's account. Also, based on the rendered transactions, the OPS makes a determination as to where TMOs should eventually be displayed (i.e., “placed”) on the consumer's transactions display pursuant to offer placement criteria (typically defined by advertisers 213 during campaign generation).

At steps 12, 13, once retrieved, the OPS 207 sends the TMOs to the financial institution web server 219, which in turn transmits the TMOs to the consumer's browser via the previously supplied network return pathname. At step 14, upon receipt of the TMOs, the client browser continues execution of the DOM Injection Script and inserts (injects or merges) the TMOs into their appropriate display locations on the consumer's financial institution portal web page in accordance with predetermined placement information (thereby rendering a display similar to that shown in FIG. 16).

As will be understood by those skilled in the art, the specific steps shown in FIG. 14 are presented for illustrative purposes only, and other methods for injecting and displaying TMOs to consumers are possible according to various embodiments. For example, rather than using a DOM injection process, other cross-site scripting mechanisms may be used. Or, in an alternate embodiment, rather than the client browser making the call for TMOs, the bank web server 219 makes the call to the local OPS server before the consumer's transactions display web page is ever rendered. While this server-side approach performs generally the same functions as a DOM injection approach, many financial institutions prefer the DOM injection because it enables minimal intrusiveness and restructuring of a financial institution's internal architecture and software. Further, although the preferred embodiment is described in terms of interaction between a client browser (i.e., consumer), a financial institution web server, and an OPS server, it should be understood that various system architectures, script call codes, and other system components may be utilized according to various embodiments. For example, the computer code used for cross-site scripting could be stored and executed on a server external to the OPS (assuming that appropriate security mechanisms were employed), or all processes could take place within the financial institution computer system, etc. It will thus be appreciated that virtually any mechanism for injecting TMOs into financial institution transactions displays may be used in association with embodiments of the present system, assuming those mechanisms comply with financial institution security protocols as outlined herein.

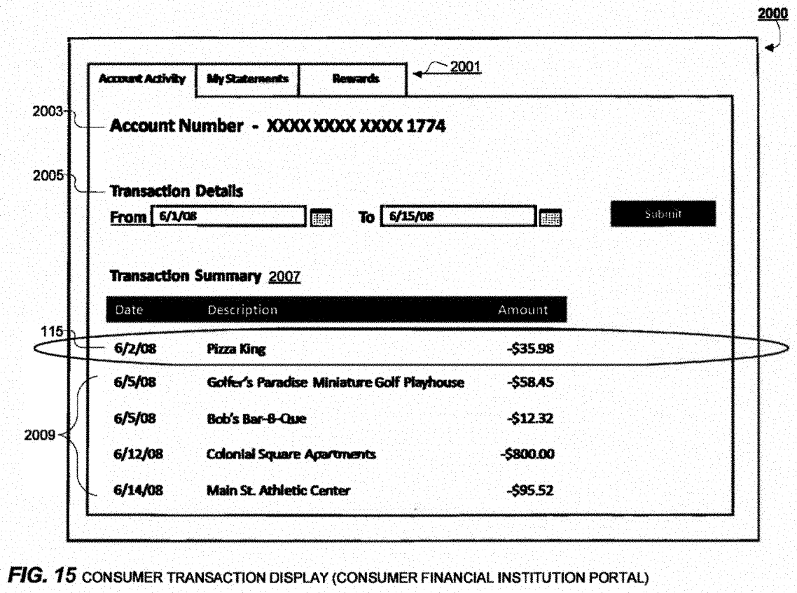

FIG. 15 illustrates an exemplary screen shot of a GUI associated with a typical exemplary consumer financial institution portal 2000 prior to injection of one or more TMOs into the portal. Through this portal, consumers 103 are able to view and manage their financial institution accounts, review prior transactions and purchases 2009, and carry out other banking-related functions. As will be understood and appreciated, the GUI shown in FIG. 15 is presented for illustrative purposes only, and the actual format and display of each GUI varies depending on the particular financial institution 205.

As shown, the exemplary portal display 2000 includes account management tabs 2001, an account number display 2003, a transactions details section 2005, and a transactions summary section 2007 for displaying previous transactions 2009 completed during a given time period. The foregoing display is an example of an account history page, discussed above. The representative consumer portal display 2000 also includes the representative OQP 115 made at Pizza King (discussed for exemplary purposes in other parts of this disclosure). Because the display 2000 shown in FIG. 15 is representative of a conventional and unmodified display from a financial institution 205, it does not include any TMOs.

FIG. 16 illustrates an exemplary screen shot of a GUI associated with a consumer financial institution portal or display 2100 with multiple exemplary TMOs 113 displayed therein according to an embodiment of the various inventions described herein. As shown, the portal display 2100 mirrors the display shown in FIG. 15, but with an associated TMO 113 a displayed in perceptible association with (i.e. close proximity to) its corresponding OQP 115. In the display shown, the representative Pizza Pub TMO 113 a is displayed immediately under the Pizza King OQP 115. Also shown in the portal display 2100 are several other TMOs 113 b listed in a side-bar section of the display. According to one embodiment, these TMOs 113 b are associated with an OTE other than a specific transaction, and are displayed based on some criteria associated with the consumer's spending habits. Alternatively, the TMOs 113 b may comprise TMOs specifically linked to specific, individual transactions of the consumer, but are merely displayed generally in the portal as opposed to in relative juxtaposition to the transactions themselves. As will be understood, however, embodiments of the present system 215 may display TMOs and advertisements according to various methods, such as directly under listed transactions, in banner advertisements, pop-up advertisements, etc., and such embodiments are not limited to the type of offer display shown in FIG. 16. As will also be understood, the TMOs shown in FIG. 16 are a result of the injection process 1900 described previously, in which matched offers are retrieved from the matched offer table 1800 and merged into existing financial institution portal displays to transform the portal displays.

As mentioned previously, the displayed TMOs 113 remain available for viewing as long as the consumer's OQP 115 is available for review, or as long as the OTE applies, or as long as dictated by the advertiser 213 when the offer or campaign was created. As will be appreciated, consumers may receive multiple TMOs within display 2100 if many of the consumer's transactions satisfy one or more TCS's within the system 215. Further, as will be understood, there are circumstances in which a given consumer fails to qualify to receive any TMOs because none of his or her transactions satisfy any TMO segment dimensions. In these circumstances, the consumer's financial institution portal remains unchanged, such as that shown in FIG. 15. Additionally, as will be understood and appreciated, TMOs are displayed to consumers 103 via any viewable portal display, such as those on a mobile device (e.g., cell phone), laptop computer, desktop computer, or any other similar display.

### Offer Realization/Redemption

FIG. 17 is a flowchart illustrating an embodiment of a computer-implemented redemption process 2300 within the OPS 207 for determining whether one or more TMOs have been redeemed by a consumer, according to one aspect of disclosure. The embodiment of the redemption process shown in FIG. 17 also includes the functions of crediting redemptions to each respective financial institution's consumers and providing reporting and billing functions related to redemptions for advertisers. The redemption process 2300 is typically carried out in a particular machine, in this case an OPS 207 associated with a particular financial institution that employs aspects of the disclosed system.

Starting at step 2301, an OPS 207 monitors for incoming de-identified consumer transaction data from its respective associated financial institution. If no data is received, then the process 2300 loops to step 2301, and the OPS again monitors for incoming data (step 2303). Just as with other recurring processes discussed herein, steps 2301, 2303 are repeated either continuously or on a recurring, periodic basis.

If de-identified consumer transaction data is received, then the data is stored within the de-identified consumer transaction table 1700 within the OPS database 307 (step 2305). If any of the merchant names in the de-identified consumer transaction data cannot be identified, the names are transmitted to the OMS for merchant identification before any redemptions are determined for the specific transactions. Next, the OPS accesses the matched offer table 1800 from within the OPS database 307, compares the de-identified consumer transaction data (using the validated merchant name(s)) to the data in the matched offer table, and determines whether one or more previously-placed TMOs have been redeemed by one or more consumers (steps 2307, 2309). In one embodiment, step 2309 is performed by a predetermined algorithm that compares each transaction received from the financial institution (for example, a list of transactions such as those shown in table 1700) for a particular consumer with that consumer's previously-placed TMOs) in the matched offer table 1800 to determine if any of the offer criteria of the TMOs displayed to the consumer have been satisfied. As described elsewhere herein, each TMO generally defines one or more offer criteria necessary to redeem the TMO, such as “$10 off any purchases of $25 or more made at a Pizza Pub in June”. Thus, if one of the transactions received from the financial institution meets the defined criteria of an offer associated with the given consumer's account, then the TMO is defined as redeemed. In one embodiment, each consumer's matched offers are stored in a separate matched offer table or file 1800 to simplify the comparison process of step 2309 (as well as the previously-discussed injection process 1900).

If no TMOs are determined redeemed (based on the results of step 2309), then the redemption process 2300 for the particular set of de-identified consumer transaction data is ended (step 2311). If, however, a TMO is determined redeemed, then OPS utilizes a pre-determined conversion algorithm to automatically convert the redemption value, as stipulated by the originally-presented TMO 113, into the appropriate rewards type (if different from cash) for the account associated with the RQP 117 in which the TMO was redeemed (step 2313). For example, a financial institution 205 may dictate that $1.00 in offer value is equivalent to 3 airline miles. Thus, if an offer value of $10.00 was redeemed, the consumer account will receive 30 airline miles. Once the reward value has been converted (if necessary), the redemption is recorded by the OPS 207 in an offer redemption table 2500 (see FIG. 19 and its associated discussion) (step 2315) in the OPS database 307. Depending on the particular embodiment, details associated with the RQP are recorded, such as the time and/or date of the RQP, the specific advertiser location at which the RQP occurred, and other similar data (see exemplary data structure 2500). In one embodiment, the OPS will provide its associated financial institution(s) with a report or notification of all RQPs having occurred within a defined period of time, which the financial institution will in turn utilize to issue offer redemption payment(s) to the appropriate consumer account(s) (step 2317).

In general, the financial institution 205 is directly reimbursed for the value of each reward paid to a consumer by the TMS, which in turn receives payment from advertisers for all redeemed TMOs. Additionally, in one embodiment, an operator of the TMS charges advertisers a fee to create and execute targeted marketing campaigns. When a consumer 103 subsequently logs in to his or her financial institution portal 2100 to view his or her account activity, the OPS 207 performs a process similar to the injection process 1900 shown in FIG. 13, although rather than merging matched offers into the portal display, the OPS injects a notice or icon 119 indicating that the consumer has received an ORP 225 (see FIG. 21 and associated discussion).

As will be understood and appreciated by one having ordinary skill in the art, in order to redeem TMOs according to discussed embodiments of the present system 215, a consumer 103 is not required to cut out and use any coupons, print out any advertisements, enter in any promotion codes, etc. (although, an advertiser can mandate such coupon usage, if desired). Generally, all that is required is for a consumer to make a RQP 117 using a payment mechanism associated with the account in which the original OQP 115 was made. Once a consumer makes such a RQP, the associated redemption payment is automatically issued to the consumer's account, as described herein.

FIG. 18 is an exemplary offer impression table 2400 illustrating recorded TMOs that have been viewed by consumers 103 based on consumer log-ins to financial institution portals. FIG. 19 is an exemplary offer redemption table 2500 illustrating TMOs that have been redeemed by consumers based on RQPs 117. As will be understood, tables 2400, 2500 are presented for illustrative purposes only, and embodiments of the present system 215 are not limited to use of the specific data tables shown. Each of the tables 2400, 2500 comprises a plurality of entries representing offer impressions and offer redemptions, respectively, each entry comprising a plurality of data categories or fields.

As shown, the each entry in the tables 2400, 2500 includes four data categories or fields: offer identifier 2401, 2501, account global unique identifier 2403, 2503, date (either of impression or redemption) 2405, 2505, and time (either of impression or redemption) 2407, 2507. As will be understood, however, the data categories or files are not limited to the fields shown, and other embodiments include additional fields as will occur to one of ordinary skill in the art.

Additionally, in one embodiment, not all data shown in tables 2400, 2500 is recorded (e.g., time of impression or redemption is not necessarily recorded). As will also be understood, although only five data entries are shown in table 2400 (i.e., entries corresponding to GUIDs 12932, 49830, etc.), and three data entries are shown in table 2500 (i.e., entries corresponding to GUIDs 12932, 80204, etc.), actual data tables constructed in accordance with aspects of the present system may include a virtually unlimited number of entries corresponding to a plurality of impressions and/or redemptions recorded by embodiments of the present TMS 215.

As shown, the offer ID fields 2401, 2501 and account GUID fields 2403, 2503 correspond to similar fields and data entries shown and discussed previously in conjunction with FIG. 6C, etc. These fields identify the particular TMOs that are either viewed or redeemed by consumers, as well as the corresponding consumer accounts associated with the offers. The date fields 2405, 2505 and time fields 2407, 2507 indicate the specific dates and times that TMOs are viewed and/or redeemed, respectively. Again, the data fields referred to herein are not limited by the specific fields shown in FIGS. 18 and 19, and other data items are contemplated, such as the number of times each TMO is viewed (i.e., number of impressions), specific advertiser location at which a TMO is redeemed, the spend amount associated with each redemption, and other similar data fields. Generally, the data shown in tables 2400, 2500 is utilized for purposes of issuing redemptions to consumers. Further, according to one embodiment, the data shown in tables 2400, 2500 is aggregated (i.e., see campaign results table 2600), and used for reporting campaign performance to advertisers. Additionally, as shown, the representative impression and redemption 2409, 2509 correspond to the Pizza Pub/Pizza King example referenced in other parts of this disclosure.

FIG. 20 is an exemplary campaign results table 2600 illustrating aggregated TMO performance data (i.e., offer impressions and redemptions). The aggregated TMO performance data comprises a plurality of individual entries of results for a TMO, each entry including a plurality of data fields. As shown, each entry in the table 2600 includes three data categories or fields: offer identifier 2601, offer impressions 2603, and offer redemptions 2605. These fields thus relate specific results of offer impressions and offer redemptions with a particular identified TMO, within a campaign as delimited by means not shown, such as a particular reporting period, or for a particular advertiser, etc. As will be understood, however, the data categories or files are not limited to the fields shown, and other embodiments include additional fields as will occur to one of ordinary skill in the art. As will also be understood, although only three data entries are shown in table 2600 (i.e., entries corresponding to offer IDs 99999, 40568, etc.), actual data tables constructed in accordance with aspects of the present system may include a virtually unlimited number of entries corresponding to campaign results data 301 recorded by embodiments of the present TMS 215.

As shown, offer impressions field 2603 illustrates exemplary, aggregated TMO impressions associated with specific TMOs. Offer redemptions field 2605 illustrates exemplary, aggregated offer redemptions associated with specific TMOs. According to one embodiment, this data is aggregated within each OPS 207 and transmitted to the OMS 211 for reporting to advertisers 213. As will be understood, various other types of data is included in the campaign results table 2600 according to various embodiments, including the number of times a TMO is “clicked” (i.e., accessed with a mouse or cursor) for additional information by a consumer within a financial institution portal, information entered by a consumer into a data entry field associated with a TMO, etc. Additionally, as shown, the representative results entry 2607 corresponds to the Pizza Pub/Pizza King example referenced in other parts of this disclosure.

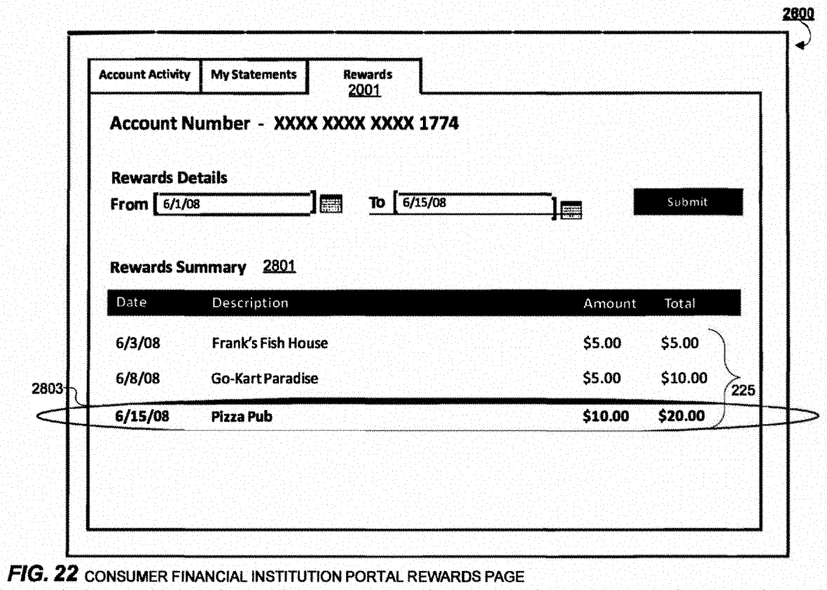

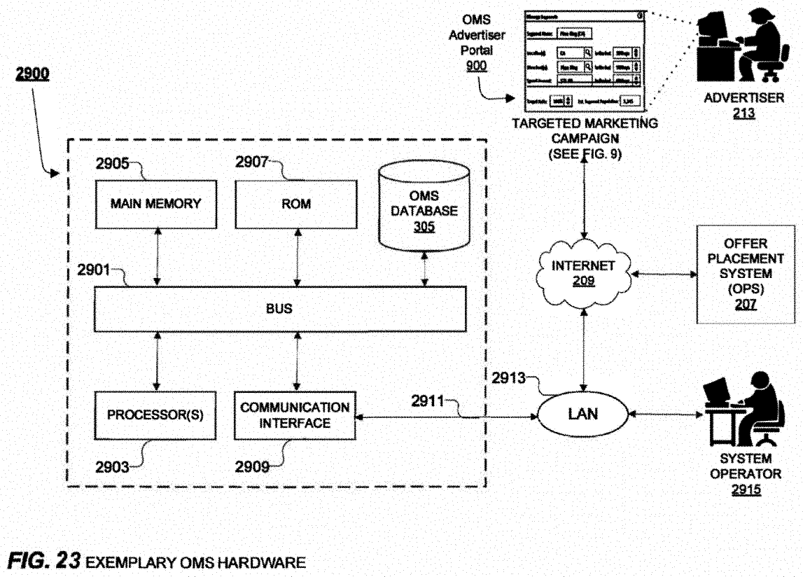

FIG. 21 illustrates an exemplary screen shot of a GUI associated with a consumer financial institution portal 2700 with TMO 113, a RQP 117, and a RQP icon 119 displayed therein according to an embodiment of the present TMS 215. As shown, the portal display 2700 mirrors the display shown in FIG. 16, but with the associated RQP and RQP icon indicated accordingly. The exemplary RQP 117 satisfies the criteria defined in the original exemplary TMO 113 a (i.e., purchase made at a Pizza Pub, in June, for more than $25), and thus the representative consumer account shown is credited the $10 dictated in the TMO (see FIG. 22 for exemplary rewards page) as constituting an offer redemption payment 225.

As mentioned previously, because the RQP is carried out using a payment mechanism associated with the account with which the original OQP was made (as evidenced by the fact that the RQP is listed on the same account summary web page as the OQP), the OPS 207 automatically recognizes the RQP and instructs the financial institution 205 to pay an associated redemption payment or reward to the consumer 103. According to one embodiment of the present system 215, rewards (i.e., ORPs 225) are indicated on a separate rewards page (e.g., FIG. 22). In other embodiments, however, ORPs are indicated in the amount column 2701 of a transaction summary 1707 (e.g., the amount for the representative RQP 117 would read $18.93 instead of $28.93), or listed underneath the RQP itself, or indicated via some other similar display mechanism.

As shown in FIG. 21, a RQP icon 119 is provided in relative juxtaposition with the RQP 117, thus indicating that the given transaction is in fact a RQP, and that an associated ORP 225 has been or will be issued to the particular consumer's account. The exemplary RQP icon is shown in FIG. 21 as a circle with a dollar sign contained therein, but other types of icons and icon images are contemplated according to various embodiments of the present system, and can be configured uniquely for each financial institution. Accordingly, aspects of the present system are not limited by the specific example icon or display format shown. Further, in the embodiment shown, when a consumer 103 hovers a cursor over the RQP icon 119, or clicks or otherwise interacts with the icon via the financial institution portal 2700, a pop-up redemption message 2703 is displayed to the consumer thanking the consumer for the purchase 117 and describing the savings or reward that was issued to the consumer. As will be understood and appreciated, the icon 119 and redemption message 2703 are presented for illustrative purposes only, and the formats and overall use of these elements may vary according to various embodiments of the present system. Further, some embodiments do not use a RQP icon 119 or a redemption message 2703, and merely issue automatic redemptions or rewards to consumers' accounts. Additionally, for TMOs that do not present possible redemptions, and are merely advertisements for a particular advertiser, no ORP is issued and no RQP icon is shown, as there is no potential redemption available with the TMO.

FIG. 22 illustrates an exemplary screen shot of a GUI associated with a consumer financial institution portal displaying a representative rewards page 2800 according to an embodiment of the present TMS 215. As will be understood and appreciated, the rewards page 2800 may be incorporated into a financial institution's existing, conventional account rewards page, or may comprise a separate page only displaying rewards associated with embodiments of the TMS 215. As will also be understood, regardless of the format of the rewards page, or any other exemplary screen shot or web page discussed herein, each page integrates seamlessly and adapts to the particular online format of each respective financial institution 205.

As shown, rewards tab 2001 is selected, indicating a rewards display page 2800 within the consumer financial institution portal. The rewards page 2800 includes a rewards summary section 2801 listing recent ORPs 225 issued to the particular consumer 103. Exemplary reward 2803 indicates the $10 cash back received in association with the Pizza Pub transaction (shown and discussed previously). Although the redeemed rewards 225 are shown in FIG. 22 as credits or cash back, other aspects of the present system incorporate other forms of rewards, such as airline miles, points, etc. (discussed previously). In one embodiment, the consumer 103 has the option of redeeming the displayed rewards (i.e., receiving a paper check or a credit to one of the consumer's accounts). In another embodiment, the rewards are automatically issued to the consumer's account in the form of a credit or otherwise. Typically, the rewards associated with TMOs according to embodiments of the present TMS 215 are handled in a similar manner as conventional rewards programs run by financial institutions, and, generally, each financial institution has discretion as to how rewards are issued.

Similar to the rewards page 2800 shown in FIG. 22, some embodiments of the present system 215 incorporate an TMO(s) detail page (not shown) that lists or displays all pending and/or past TMOs presented to a given consumer 103, as well as the status of those TMOs (i.e., available, redeemed, expired, etc.). In the offer(s) detail page, a consumer has the ability to view his or her TMOs 113 collectively in a centralized location and across many accounts rather than separately under each account page and OQP 115. An offer(s) detail page is especially useful in circumstances in which a consumer has many transactions associated with a given account, or has many accounts with one financial institution 205. By collecting the TMOs on one page, the consumer is able to conveniently and quickly review all available TMOs associated with his or her financial institution accounts, as well as keep track of prior redemptions.

As mentioned previously, as consumers 103 view and/or redeem TMOs, these offer impressions and/or redemptions are recorded by each OPS 207, aggregated, and subsequently transmitted to the OMS 211 for reporting and billing purposes. Advertisers 213 are able to view such campaign results data 301 and assess the overall success (i.e., performance) of their advertising campaigns. Through this data, advertisers are able to determine which aspects of campaigns and TMOs generate high response rates and consumer interaction, and which do not. This information is utilized to shape future campaigns and TMOs in highly targeted ways to produce maximum consumer response. Again, this highly valuable form of marketing is based on consumer spending habits, yet also accomplished without disclosure of confidential or private consumer information to any outside parties.

FIG. 23 illustrates an exemplary OMS hardware architecture 2900 upon which an embodiment of the OMS may be implemented as herein described. FIG. 24 illustrates an exemplary OPS hardware architecture 3000 upon which an embodiment of the OPS may be implemented as herein described. As shown in FIGS. 23-24 and described previously herein, the hardware components of the OMS 211 and OPS 207 are specifically designed to carry out the particular functions and processes of the TMS 215 (i.e., they are particular machines). As will be understood and appreciated, the hardware representations 2900, 3000 are shown for illustrative purposes only, and other hardware variations will occur to those of ordinary skill in the art. Further, the hardware implementations shown in FIGS. 23-24 do not necessarily include representations of detailed hardware connections via firewall(s) 330, reverse proxies 217, and other system architecture components shown and described previously herein.

As shown, both the OMS and OPS include a bus 2901, 3001 or other communication mechanism for communicating information, and one or more processors 2903, 3003 coupled with the bus for processing information. The OMS and OPS each also include a main memory 2905, 3005, such as a random access memory (RAM) or other similar dynamic storage device, coupled to the bus 2901, 3001 for storing instructions and information to be executed by the processor(s) 2903, 3003. In addition, main memory 2905, 3005 may be used for storing temporary variables or other intermediate information during execution of instructions to be executed by the processor(s). As shown, the OMS and OPS both include a read only memory (ROM) 2907, 3007 or other similar static storage device coupled to the bus for storing static information and instructions for the processor(s). Also included within the OMS and OPS are OMS database 305 and OPS database 307, respectively, which are coupled to their respective buses and used for storage and retrieval of various types of system data as previously described. In one embodiment, as shown previously in FIG. 3, the OPS database 307 (and database server) reside separate and apart from an OPS web server, such that the OPS database resides behind one or more additional financial institution firewalls 330.

The OMS and OPS hardware systems 2900, 3000, respectively, both include a communication interface 2909, 3009, coupled to the communication bus 2901, 3001, which provide two-way data communication coupling to a network link 2911, 3011 that is connected to a local area network (LAN) 2913, 3013. The communication interface 2909, 3009 generally comprises an Ethernet or similar network interface card, a digital subscriber line (DSL), or other similar interface. The network link 2911, 3011 may comprise a wireless link, hard-wired link, or other similar link. Additionally, for ease of reference, firewall(s), reverse proxies 217, DMZ(s), and other ancillary components are not shown in FIGS. 23-24, but it will be understood that these components comprise a part of the overall hardware architecture of embodiments of the present system.

For the embodiment of the OMS 211 shown in FIG. 23, the network link provides data communication through the LAN 2913 to the OMS advertiser portal 900 and each OPS 207 (via the Internet 209), and the system operator management portal 2915. Thus, all information transmitted to and from the OPS, or advertisers via the OMS advertiser portal, or system operators, is transmitted via the communication link 2911. The system operator management portal 2915 provides access by a system operator or manager to the overall TMS 215. According to various embodiments and as will be understood, the system operator manages system performance, predefines system parameters, updates system software, and provides a host of other system management functions. For the embodiment of the OPS 207 shown in FIG. 24, the network link 3011 provides data communication through the LAN 3013 to the OMS 211 (via the Internet 209) and a respective financial institution web server 219 (and further to a financial institution transaction processor 220, not shown). Again, the hardware components and connections illustrated in FIGS. 23-24 are presented for illustrative purposes only, and other system configurations are possible according to various embodiments of the present inventions.

The foregoing description of the exemplary embodiments has been presented only for the purposes of illustration and description and is not intended to be exhaustive or to limit the inventions to the precise forms disclosed. Many modifications and variations are possible in light of the above teaching.

The embodiments were chosen and described in order to explain the principles of the inventions and their practical application so as to enable others skilled in the art to utilize the inventions and various embodiments and with various modifications as are suited to the particular use contemplated. Alternative embodiments will become apparent to those skilled in the art to which the present inventions pertain without departing from their spirit and scope. Accordingly, the scope of the present inventions is defined by the appended claims rather than the foregoing description and the exemplary embodiments described therein.

We claim:

1. A targeted marketing system operative to deliver a targeted marketing offer from an advertiser to a selected consumer of a financial institution in the form of a targeted marketing offer on a client device operated by the selected consumer, the client device in communication with a financial institution computer system, the client device displaying the targeted marketing offer to the selected consumer in association with a display of a consumer's financial transaction received from the financial institution computer system, the targeted marketing system comprising:
a database for receiving authorization data from the financial institution computer system, the authorization data including data associated with transactions made by the selected consumer with a plurality of merchants, each record of the authorization data including at least a field identifying the selected consumer and a field containing raw data corresponding to an associated transaction;
a merchant identification system coupled to the database, for identifying from the raw data of each record of the authorization data a selected merchant involved with the associated transaction with the selected consumer;
an aggregator system for receiving the identified selected merchant from the merchant identified system, and aggregating the identified selected merchant associated with the selected consumer along with other ones of the plurality of merchants involved in other transactions with the selected consumer, thereby creating an aggregated record including a field associated with the selected consumer and a plurality of fields including the aggregated merchants which have transacted with the selected consumer;
a transaction prediction system coupled to the aggregator system, for generating a list of recommended merchants with which the selected consumer may perform transactions in the future, based on the aggregated merchants in the aggregated record associated with the selected consumer; and
an offer targeting system for causing the client device to display a marketing offer associated with at least one of the list of recommended merchants to the selected consumer, in association with the display of the consumer's financial transaction by the client device, wherein the offer targeting system displays the marketing offer in real time with respect to the transactions made by the selected consumer.

2. The targeted marketing system of claim 1, wherein the selected consumer is identified by the targeted marketing system in a de-identified manner, whereby the identity of the selected consumer cannot be discovered by the advertiser.

3. The targeted marketing system of claim 1, wherein the client device is a mobile device.

4. The targeted marketing system of claim 1, wherein the client device is a smartphone.

5. The targeted marketing system of claim 1, wherein the client device is a computing device.

6. The targeted marketing system of claim 1, wherein the authorization data comprises the fields of: Account ID, authorization date and time, and an authorization string.

7. The targeted marketing system of claim 6, wherein the authorization string comprises a string as configured at a transaction terminal maintained at the site of one of the plurality of merchants.

8. The targeted marketing system of claim 1, wherein the merchant identification system performs the steps of:
comparing the raw data of each record of the authorization data against a list of known merchants each having an associated known raw data pattern;
if the raw data matches the known raw data pattern of a selected one of the known merchants, then identifying the selected known merchant as the selected merchant;
if the raw data does not match the known raw data pattern of a selected one of the known merchants, then performing a predictive merchant process to identify the selected merchant.

9. The targeted marketing system of claim 8, wherein the predictive merchant process is performed using a neural network multiclass classification process.

10. The targeted marketing system of claim 8, wherein the predictive merchant process is performed using a text classification model to detect merchant name patterns.

11. The targeted marketing system of claim 1, wherein the transaction prediction system uses an auto encoder network.

12. A computer-implemented method for delivering a targeted marketing offer from an advertiser to a selected consumer of a financial institution in the form of a targeted marketing offer on a a client device operated by the selected consumer, the client device in communication with a financial institution computer system, the client device displaying the targeted marketing offer to the selected consumer in association with a display of a consumer's financial transaction received from the financial institution computer system, the method comprising the steps of:
receiving authorization data from the financial institution computer system, the authorization data including data associated with transactions made by the selected consumer with a plurality of merchants, each record of the authorization data including at least a field identifying the selected consumer and a field containing raw data corresponding to an associated transaction;
identifying from the raw data of each record of the authorization data a selected merchant involved with the associated transaction with the selected consumer;
receiving the identified selected merchant, and aggregating the identified selected merchant associated with the selected consumer along with other ones of the plurality of merchants involved in other transactions with the selected consumer, thereby creating an aggregated record including a field associated with the selected consumer and a plurality of fields including the aggregated merchants which have transacted with the selected consumer;
generating a list of recommended merchants with which the selected consumer may perform transactions in the future, based on the aggregated merchants in the aggregated record associated with the selected consumer; and
causing the client device to display a marketing offer associated with at least one of the list of recommended merchants to the selected consumer, in association with the display of the consumer's financial transaction by the client device, wherein the client device displays the marketing offer in real time with respect to the transactions made by the selected consumer.

13. The computer-implemented method of claim 12, wherein the selected consumer is identified by the targeted marketing system in a de-identified manner, whereby the identity of the selected consumer cannot be discovered by the advertiser.

14. The computer-implemented method of claim 12, wherein the client device is a mobile device.

15. The computer-implemented method of claim 12, wherein the client device is a smartphone.

16. The computer-implemented method of claim 12, wherein the client device is a computing device.

17. The computer-implemented method of claim 12, wherein the authorization data comprises the fields of: Account ID, authorization date and time, and an authorization string.

18. The computer-implemented method of claim 17, wherein the authorization string comprises a string as configured at a transaction terminal maintained at the site of one of the plurality of merchants.

19. The computer-implemented method of claim 12, wherein the identifying step performs the steps of:
comparing the raw data of each record of the authorization data against a list of known merchants each having an associated known raw data pattern;
if the raw data matches the known raw data pattern of a selected one of the known merchants, then identifying the selected known merchant as the selected merchant;
if the raw data does not match the known raw data pattern of a selected one of the known merchants, then performing a predictive merchant process to identify the selected merchant.

20. The computer-implemented method of claim 19, wherein the predictive merchant process is performed using a neural network multiclass classification process.

21. The computer-implemented method of claim 19, wherein the predictive merchant process is performed using a text classification model to detect merchant name patterns.

22. The computer-implemented method of claim 12, wherein the generating step uses an auto encoder network.
